(19) United States
(12) Patent Application Publication
(10) Pub. No.: US 2013/0290541 A1
(43) Pub. Date: Oct. 31, 2013

(54) RESOURCE MANAGEMENT SYSTEM AND RESOURCE MANAGING METHOD

(71) Applicants: Keisuke Hatasaki, Kawasaki (JP); Kazuhide Aikoh, Yokohama (JP)

(72) Inventors: Keisuke Hatasaki, Kawasaki (JP); Kazuhide Aikoh, Yokohama (JP)

(73) Assignee: Hitachi ,Ltd.

(21) Appl. No.: 13/510,526

(22) PCT Filed: Apr. 25, 2012
(86) PCT No.: PCT/JP2012/002836

§ 371 Date: May 17, 2012

(51) Int. Cl. G06F 15/16

(52) U.S. Cl. 709/226

(57) ABSTRACT

An resource management system example includes node configuration information for managing a hardware configurations of nodes, virtual apparatus management information for managing virtual apparatuses operating in the nodes, and virtual storage configuration condition information for managing configurations of virtual storage apparatuses and hardware resource conditions required to satisfy the configurations of the virtual storage apparatuses in association with each other. The resource management system obtains an allocation request for a first virtual storage apparatus and information of the configuration, refers to the virtual storage configuration condition information to determine a hardware resource condition satisfying the configuration of the first virtual storage apparatus, and refers to the node management information and the virtual apparatus management information to determine a node capable of allocating a hardware resource satisfying the hardware resource condition to the first virtual storage apparatus as a node where the first virtual storage apparatus is to be configured.

### TECHNICAL FIELD

The present invention relates to a resource management system and a resource managing method, and particularly to a resource management system and a resource managing method of a computer system using virtualization technologies.

### BACKGROUND ART

In a computer system using virtualization technologies, the computer executes a virtualization program and one or more virtual machines (hereinafter also referred to as VMs) are operated. A plurality of servers can be aggregated and resource use efficiency can be improved by using the virtualization technologies.

In a prior-art cloud system, a plurality of server computers capable of operating one or more VMs are connected with a shared storage apparatus, and a hypervisor (program) operating on each server computer manages a plurality of volumes configured on the shared storage apparatus as a storage pool. The hypervisor cuts out a required capacity from the storage pool and allocates it to a VM in VM provisioning. The VM provisioning of operation applications such as business applications has been mainly performed in such a cloud system.

In a cloud system, versatile application programs and operating systems of a version compatible with them are operating, for example. Therefore, the shared storage apparatus can preferably accept access from operating systems of different versions.

Patent Literature 1 discloses that once an operating system of a host computer to make an access to a volume is determined, storage control software of a version compatible with the operating system is uploaded to a control unit of the storage apparatus and implemented. Moreover, Patent Literature 1 discloses that the storage control software of a plurality of versions is operated on one control unit utilizing a virtualization program by the control unit.

### CITATION LIST

### Patent Literature

PTL 1: U.S. Patent Application Publication No. 2008/0243947

### SUMMARY OF INVENTION

### Technical Problem

On the other hand, in a system handling a large quantity of data such as a large-scale distributed parallel processing system for a large quantity of structured and non-structured data, business intelligence and a data warehouse, an application program processing a large quantity of data and requiring a large quantity of storage I/O (Input/Output) is operated. If such an application program is operated on the prior-art cloud system, load concentration to the shared storage apparatus causes a bottleneck, and other VMs (application programs) might be affected.

In order to cope with the above, if a high-performance storage apparatus is prepared in advance assuming an application program processing a large quantity of data, it overengineers the other application programs of the business operations, and use efficiency of the storage physical resources lowers.

The present invention was made in view of the circumstances and has an object to realize flexible allocation of storage apparatuses with appropriate physical performance and configurations in accordance with operation requirements for the storage apparatuses.

### Solution to Problem

An aspect of this invention is a resource management system which manages a hardware resource pool including a plurality of nodes connected via a network. The resource management system includes: node configuration information for managing hardware configuration of each of the plurality of nodes; virtual apparatus management information for managing virtual apparatuses including virtual storage apparatuses and virtual operation computers operating in the plurality of nodes; virtual storage configuration condition information managing configurations of the virtual storage apparatuses and hardware resource conditions required to satisfy the configurations of the virtual storage apparatuses in association with each other; and a processor. The processor obtains an allocation request for a first virtual storage apparatus and information of a configuration of the first virtual storage apparatus. The processor refers to the virtual storage configuration condition information to determine a hardware resource condition satisfying the configuration of the first virtual storage apparatus. The processor refers to the node management information and the virtual apparatus management information to determine a node which is capable of allocating a hardware resource satisfying the hardware resource condition of the first virtual storage apparatus to the first virtual storage apparatus as a node where the first virtual storage apparatus is to be configured. The processor provides an instruction of allocation of the hardware resource to the first virtual storage apparatus and delivers a storage control program of the first virtual storage apparatus to the determined node in provisioning of the first virtual storage apparatus in the determined node.

### Advantageous Effects of Invention

According to an aspect of this invention, the storage apparatus with appropriate physical performance and configuration can be flexibly allocated in accordance with the operation requirements for the storage apparatus.

### BRIEF DESCRIPTION OF DRAWINGS

FIG. 1 is a block diagram for explaining a configuration example of a computer system in this embodiment.

FIG. 2 is a diagram schematically illustrating a hardware configuration example of a node included in this embodiment.

FIG. 3 is a diagram schematically illustrating a logical configuration example of the node in this embodiment.

FIG. 4 is a diagram illustrating a configuration example of a management program in this embodiment.

FIG. 5 is a diagram illustrating a configuration example of a management table in this embodiment.

FIG. 6 is a diagram illustrating a configuration example of a node configuration table in this embodiment.

FIG. 7A is a diagram illustrating a configuration example of a VM configuration table in this embodiment.

FIG. 7B is a diagram illustrating a configuration example of the VM configuration table in this embodiment.

FIG. 7C is a diagram illustrating a configuration example of the VM configuration table in this embodiment.

FIG. 8 is a diagram illustrating a configuration example of a data table in this embodiment.

FIG. 9 is a diagram illustrating a configuration example of a storage performance configuration requirement table in this embodiment.

FIG. 10 is a diagram illustrating a configuration example of a storage function configuration requirement table in this embodiment.

FIG. 11 is a diagram illustrating a program (software) included in a repository of software in this embodiment.

FIG. 12 is a flowchart illustrating a processing example by a request receiving program in this embodiment.

FIG. 13 is a diagram illustrating an example of a GUI image making a request of storage provisioning in this embodiment.

FIG. 14 is a diagram illustrating an example of a GUI image used by a user when existing data is used in creation of a virtual storage apparatus in this embodiment.

FIG. 15A is a flowchart illustrating an example of storage configuration decision processing in this embodiment.

FIG. 15B is a flowchart illustrating an example of the storage configuration decision processing in this embodiment.

FIG. 15C is a flowchart illustrating an example of the storage configuration decision processing in this embodiment.

FIG. 15D is a flowchart illustrating an example of the storage configuration decision processing in this embodiment.

FIG. 16 is a flowchart illustrating an example of operation configuration decision processing in this embodiment.

FIG. 17 is a flowchart illustrating an example of decision processing of node close to virtual storage apparatus in this embodiment.

FIG. 18 is a flowchart illustrating an example of storage provisioning processing in this embodiment.

FIG. 19 is a flowchart illustrating an example of operation provisioning processing in this embodiment.

FIG. 20 is a flowchart illustrating an example of access setting processing in this embodiment.

FIG. 21 is a flowchart illustrating an example of resource release processing in this embodiment.

FIG. 22 is a flowchart illustrating an example of troubleshooting processing in this embodiment.

### DESCRIPTION OF EMBODIMENTS

An embodiment of the present invention will be described below by referring to the attached drawings. This embodiment is only an example for embodying the present invention and not intended to limit the technical scope of the present invention.

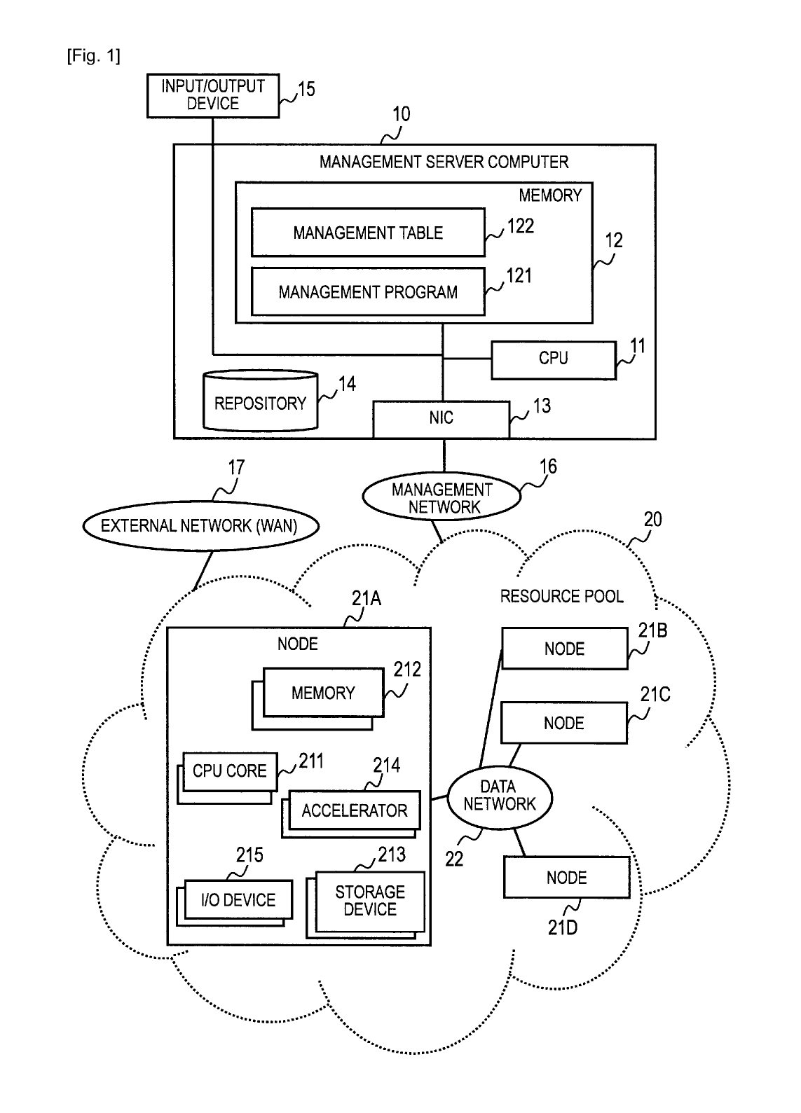

FIG. 1 is a block diagram illustrating a configuration example of a computer system in this embodiment. The computer system in this embodiment includes a management server computer 10, an input/output device 15 of the management server computer 10, a management network 16, a plurality of nodes 21A to 21D, and a data network 22.

In this configuration example, hardware resources (physical resources) provided in the nodes 21A to 21D and the data network 22 are managed as a single resource pool 20. The nodes 21A to 21D are capable of communication via the data network 22. In this example, the system includes the four nodes 21A to 21D, but the number of nodes included in the system depends on the system design, and hardware configurations of the nodes 21A to 21D are also varied depending on each design. The nodes 21A to 21D are capable of communication with a node outside the resource pool 20 via an external network 17.

The management server computer 10 manages the entire computer system. The management server computer 10 also manages the resource pool 20. The management server computer 10 and each of the nodes 21A to 21D are connected via the management network 16. The management server computer 10 can obtain necessary information from each of the nodes via the management network 16 and can give necessary information (including programs) to each of the nodes 21A to 21D.

The management server computer 10 includes a CPU 11 as a processor, a memory 12, a NIC (Network Interface Card) 13, and a repository 14. The CPU 11 executes the program expanded on the memory 12. Execution of the predetermined program by the CPU 11 can realize a function of the management server computer 10, and the CPU 11 functions as a management unit by operating in accordance with a management program 121. The management server computer 10 is a device including the management unit.

The memory 12 stores programs executed by the CPU 11 and information required for execution of the programs. Specifically, the memory 12 stores the management program 121 and a management table 122. Any other programs may be stored therein.

For the convenience of explanation, the management program 121 and the management table 122 are shown in the memory 12 which is a main storage, but typically, the management program 121 and the management table 122 are loaded from a storage region in a secondary storage device (not shown) to a storage region of the memory 12. The secondary storage device is a storage device provided with non-volatile non-temporary storage medium which stores programs and data required for realizing predetermined functions. The secondary storage device may be an external storage device connected via a network.

The management program 121 manages the resource pool 20 by using information of the management table 122. When processing is described below by using the management program 20 as a subject, it means that the management program 20 is executed by the CPU 11. The details of the management program 20 will be described later. The functions realized by the management program 20 may be implemented as the management unit by hardware and firmware or a combination thereof implemented in the management server computer 10. The relationship between the processor and the program also applies to the nodes in the resource pool 20.

The NIC 13 is an interface to be connected to the nodes 21A to 21D included in the resource pool 20, and an IP protocol is used, for example. The input/output device 15 for operating the management server computer 10 is connected to the management server computer 10. The input/output device 15 is a device such as a mouse, a keyboard and a display and is used for input/output of information between the management server computer 10 and an administrator (also referred to as a user).

The management system of this configuration example is configured by the management server computer 10, but the management system may be configured by a plurality of computers. The processor of this management system includes CPUs of a plurality of computers. One of the plurality of computers may be a computer for display connected via a network, and the plurality of computers may realize processing equal to that of the management server computer 10 for higher speed and higher reliability of management processing.

The nodes 21A to 21D included in the resource pool 20 can have various configurations. For example, the node 21A has a plurality of types of hardware resources (physical devices) and has a plurality of resources of each type in FIG. 1. Specifically, the node 21A has a plurality of CPU cores 211, a plurality of memories 212, a plurality of storage devices (secondary storage devices) 213, a plurality of accelerators 214, and a plurality of I/O devices 215.

The node is a unit element (device) in the system managed by the management server computer 10 in the resource pool 20 and includes one or more types of one or more devices (CPU, memory, storage device, I/O device and the like) as described above. Typically, constituent element devices of the node are accommodated in one housing, but the node can have any other configurations.

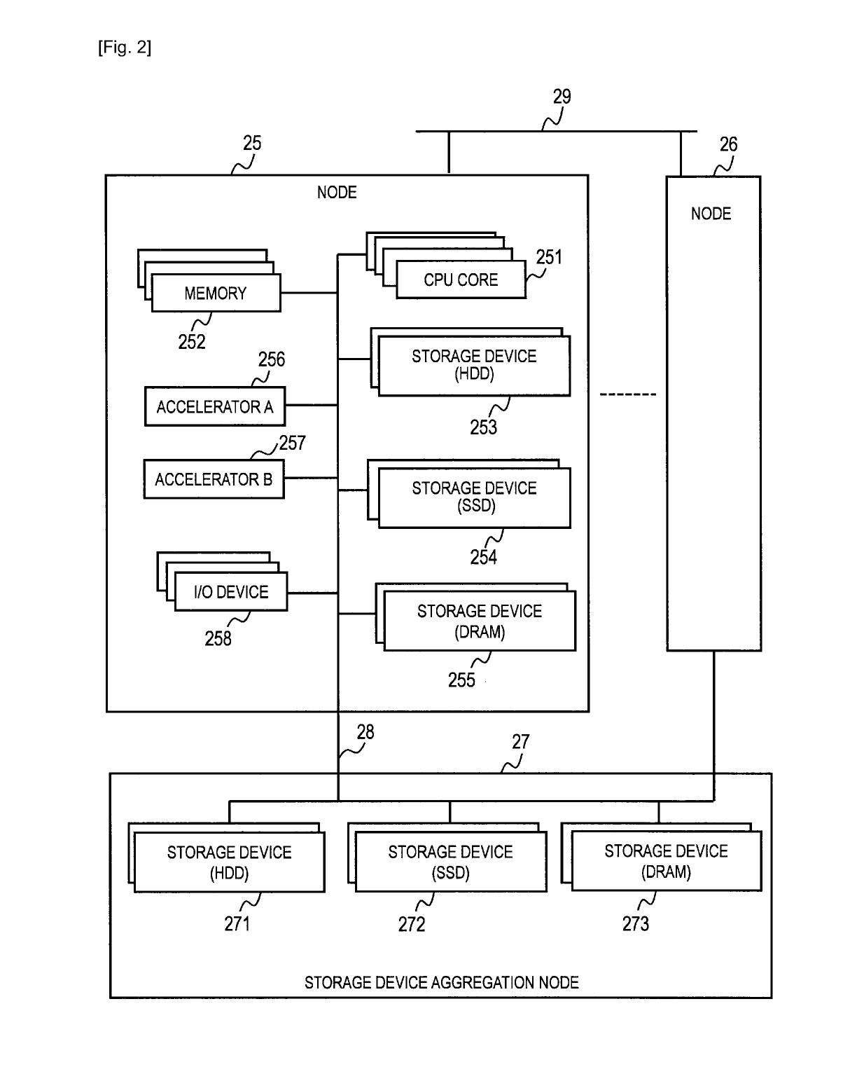

FIG. 2 is a block diagram schematically illustrating a hardware configuration example of the node included in the resource pool 20. FIG. 2 exemplifies three nodes, that is, nodes 25 and 26 and a storage device aggregation node 27. Each of the nodes 25 and 26 and the storage device aggregation node 27 is connected capable of communication by an internal connection protocol (PCI, PCIe, SCSI, InfiniBand the like) of the nodes. For example, the nodes 25 and 26 and the storage device aggregation node 27 are connected through a PCI switch 28.

The node 25 and the node 26 are connected capable of communication via a communication network 29 of a data communication protocol between the nodes such as FC (Fiber Channel), Ethernet or FCoE (Fiber Channel over Ethernet), for example. Both the communication by the communication network 29 and the PCI switch 28 is included in the communication via the data network 22 illustrated in FIG. 1.

Each of the nodes 25, 26, and 27 is provided with a plurality of types of physical devices. In the example in FIG. 2, the node 25 includes a CPU including a plurality of CPU cores 251, a plurality of memories (a memory chip or a memory board, for example) 252, a plurality of Hard Disk Drives (HDD) 253, a plurality of Solid State Drive (SSD) 254, a plurality of DRAM drives 255, an accelerator A 256, an accelerator B 257, and a plurality of I/O devices 258. The HDD 253, the SSD 254, and the DRAM drives 255 are secondary storage devices.

The CPU core 251 executes a program expanded on the memory 252. The execution of a predetermined program by the CPU core 251 can realize the function of the node 25. The memory 252 stores programs executed by the CPU core 251 and information required for executing the programs. When the node functions as a storage apparatus, the memory 252 can function as a cache memory (buffer memory) of user data.

The storage devices 253, 254, and 255 are direct access storage devices (DAS) and can store data used by the programs and user data in the node functioning as a storage apparatus.

An I/O device 258 is a device to be connected to external devices (other nodes and the management server computer 10) and is an NIC, an HBA (Host Bus Adaptor), a CAN (Converged Network Adapter) and the like, for example. The I/O device 258 includes one or more ports.

The storage device aggregation node 27 which is one of the nodes includes a plurality of HDDs 271, a plurality of SSDs 272, and a plurality of DRAM drives 273. Each of the nodes 25 and 26 can use the storage device of the storage device aggregation node 27 as its own DAS.

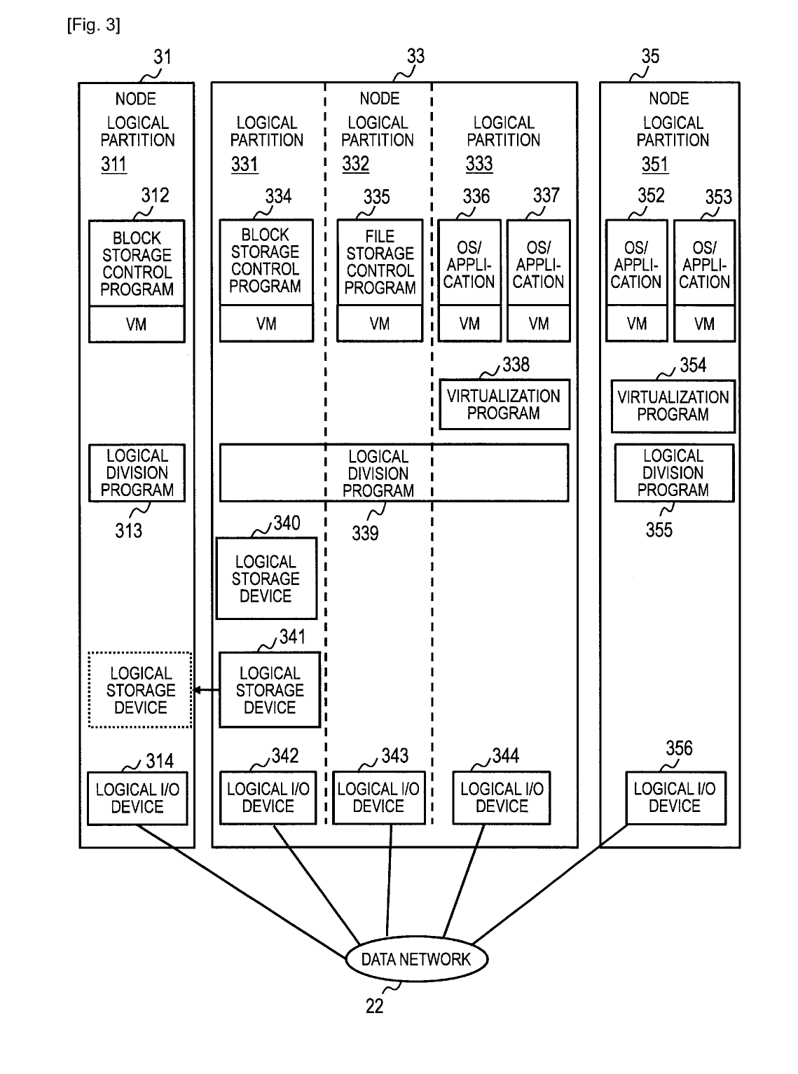

FIG. 3 schematically illustrates a logical configuration example of nodes. Three nodes 31, 33, and 35 are exemplified in FIG. 3. The nodes 31, 33, and 35 provide a virtualization environment for operating a virtual machine (VM).

Specifically, the CPU (CPU core) executes a logical partition program 313 by using a memory in the node 31, and the logical partition program 313 logically divides the hardware resource of the node 31, creates one or more logical partitions on the node 31, and manages the logical partitions. In this example, one logical partition 311 is created.

The logical partition refers to a logical partition created by dividing the hardware resource (physical resource) of a node. Partitioned hardware resources obtained by division, respectively, may be allocated to logical partitions as exclusive resources all the time. In this case, a partitioned resource obtained by division is not shared among logical partitions, ensuring the partitioned resource the logical partition. For example, allocating a storage device to a logical partition as a dedicated resource can prevent an access conflict with another logical partition and ensure the performance. Furthermore, the influence of failure of the storage device can be limited within the logical partition. Alternatively, logical partitions may share a resource. For example, logical partitions share a resource such as a CPU and network interface to use them with efficiency. In a configuration example, a CPU may be shared by logical partitions and a memory and a storage device may be dedicated to a logical partition. A method of logically dividing the hardware resource is selected as appropriate in accordance with the logical partition program and the design of the physical device. The logical partitioning program can use a logical partitioning function of the physical device and recognizes a portion of the physical device obtained by division as one physical device. The allocated hardware resource is referred to as a logical hardware resource (logical device).

An example of the method of logically dividing the plurality of CPU cores on one chip or connected by a bus and of allocating them to logical partitions is allocation of each CPU core to any one of the logical partitions. Each CPU core is exclusive for the allocated logical partition, and the allocated CPU core constitutes a logical CPU (logical device) of the logical partition.

A method of logically dividing one or a plurality of memories (physical devices) and of allocating them to logical partitions is allocation of each of a plurality of address areas in a memory region to any one of the logical partitions, for example. The allocated region is a logical memory (logical device) of the logical partition.

A method of logically dividing one or a plurality of storage devices (physical devices) and of allocating them to logical partitions is allocation of each of the storage drives, storage chips on the storage drive or predetermined address areas to any one of the logical partitions, for example. The allocated exclusive physical device element is one logical storage device of the logical partition.

A method of logically dividing one or a plurality of I/O devices (physical devices) is allocation of each I/O board or each physical port to any one of the logical partitions, for example. The allocated exclusive physical device element is one logical I/O device of the logical partition. The program can access the physical I/O device or physical storage device without using an emulator in the logical partition (pass-through).

In the logical partition 311, the allocated CPU core (logical CPU) executes a block storage control program by using the allocated memory (logical memory) and functions as a virtual machine (virtual block storage controller) 312 of a block storage controller. The logical partition 311 in which the block storage control program operates functions as a virtual block storage apparatus.

A virtual block storage controller 312 can directly access a logical storage device 341 of another node 33 (external connection function) and can take over data stored in the logical storage device 341 if a failure occurs in the node 33 (sharing of a storage device).

As described above, the hardware resource allocated to a logical partition can include a logical device of another node if a direct access can be made to the device in the node where it is formed. The virtual block storage controller 312 can connect to the data network 22 through the logical I/O device 314 and conduct communication with another node.

In FIG. 3, a logical partition program 339 is operating in the node 33 (execution by the CPU by using the memory) and creates and manages logical partitions 331, 332, and 333. Hardware resources of the node 33 obtained by logical division are directly allocated to the logical partitions 331, 332, and 333, respectively.

In the logical division 331, the block storage control program operates on the allocated CPU core and functions as a virtual machine (virtual block storage controller) 334 of the block storage controller. The logical partition 331 in which the block storage control program operates functions as a virtual block storage apparatus.

Logical storage devices 340 and 341 are allocated to the logical partition 331. The virtual block storage controller 334 stores user data of the host in the logical storage devices 340 and 341. As described above, the virtual block storage apparatus (logical partition) 331 can use a part of the physical region of the memory allocated to the logical partition 331 as cache (buffer) of the user data.

The virtual block storage controller 334 connects to the data network 22 through a logical I/O device 342 allocated to the logical partition 331 and can conduct communication with another node functioning as a host computer or a storage apparatus.

A file storage control program operates in the logical partition 332 and functions as a virtual machine (virtual file storage controller) 335 of the file storage controller. The virtual file storage controller 335 accesses the virtual block storage apparatus 331 in the same node 33 and stores and manages files including the user data of the host in the logical storage devices 340 and 341, for example. The virtual file storage controller 335 connects to the data network 22 through a logical I/O device 343 allocated to the logical partition 332 and can conduct communication with another node.

In the logical partition 333, a virtualization program 338 is operating on the allocated CPU core (logical CPU). The virtualization program 338 creates one or more VMs and operates and controls the created VMs. In this example, two VMs 336 and 337 (operation VMs) are created and operated. Each of the VMs 336 and 337 executes an operating system (OS) and an application program.

The virtualization program 338 has an I/O emulator function, and the VMs 336 and 337 can access another virtual machine in the same node through the virtualization program 338. Moreover, they can access another node through the virtualization program 338, the logical I/O device 344, and the data network 22. The VMs 336 and 337 are hosts which access the virtual file storage apparatus 332, for example. The operation VM can also operate in the logical partition without using the virtualization program 338.

In the node 35, a logical partition program 355 is operating (execution by the CPU by using the memory) and creates and manages a logical partition 351. A virtualization program 354 is operating on the allocated CPU core (logical CPU) of the logical partition 351. The function of the virtualization program 354 is the same as the virtualization program 338.

The virtualization program 354 creates one or more VMs, operates and controls the created VMs. In this example, two VMs 352 and 353 are created and operated. Each of the VMs 352 and 353 executes an operating system (OS) and an application program.

The VMs 352 and 353 can access another virtual machine in the same node through the virtualization program 354. Moreover, they can access another node through the virtualization program 354, the logical I/O device 356, and the data network 22. The VMs 336 and 337 are hosts making an access to the virtual file storage apparatus 332, for example.

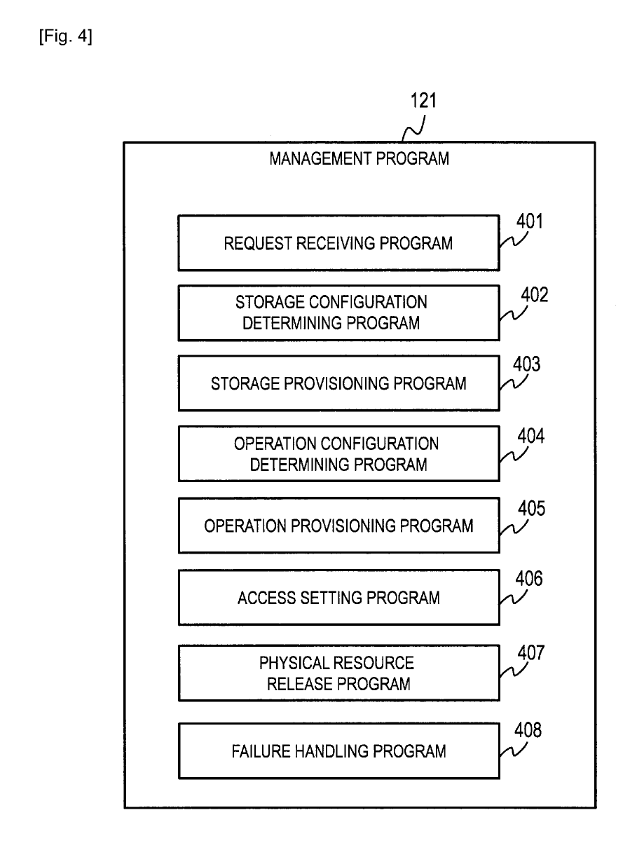

FIG. 4 is a diagram illustrating a configuration example of the management program 121 in this embodiment. The management program 20 includes a request receiving program 401, a storage configuration determining program 402, a storage provisioning program 403, an operation configuration determining program 404, an operation provisioning program 405, an access setting program 406, a physical resource release program 407, and a failure handling program 408. Details of processing of each program will be described later.

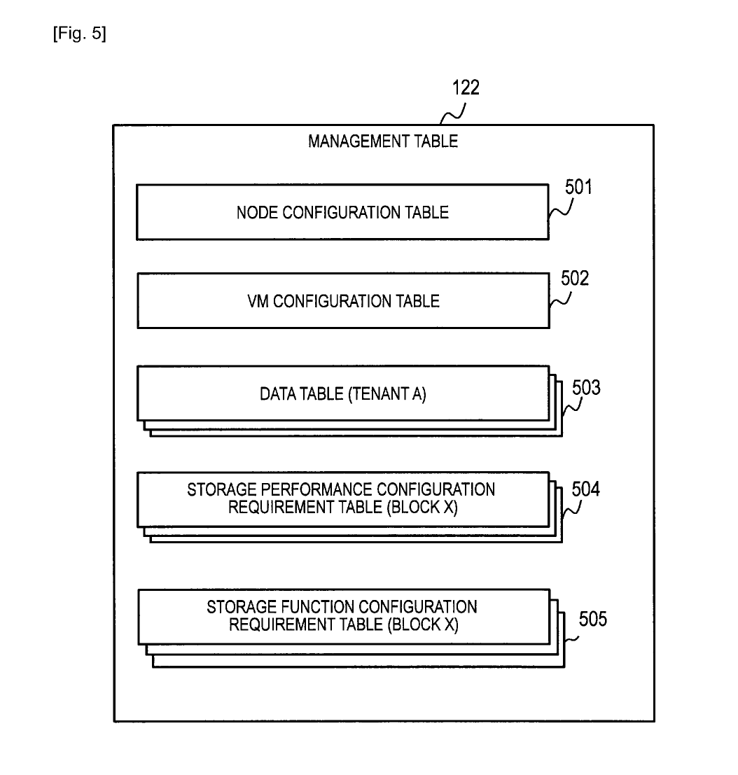

FIG. 5 is a diagram illustrating a configuration example of the management table 122 in this embodiment. The management table 122 includes a node configuration table 501, a VM configuration table 502, a data table 503, a storage performance configuration requirement table 504, and a storage function configuration requirement table 505. The data table 503 is created for each registered tenant. The storage performance configuration requirement table 504 and the storage function configuration requirement table 505 are created for each storage apparatus (storage control program) identified by the type, model, version and the like.

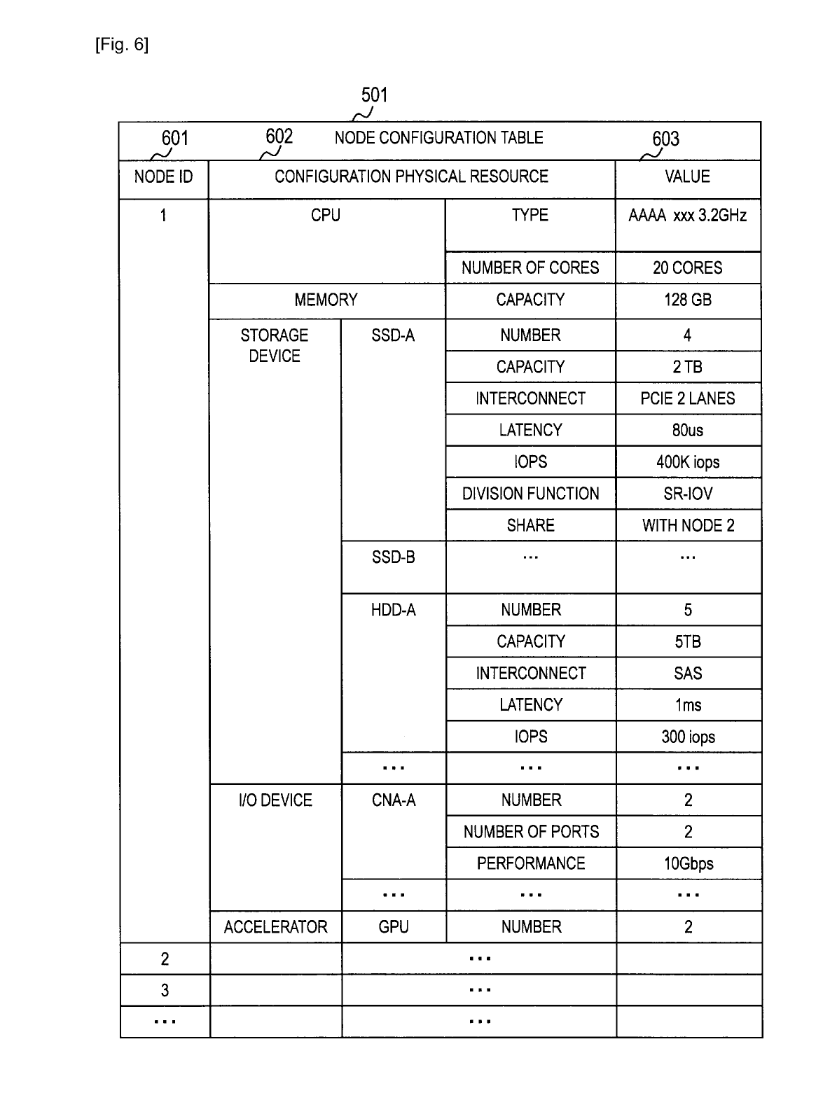

FIG. 6 illustrates a configuration example of the node configuration table 501. The node configuration table 501 manages information of hardware configuration (physical configuration) of each node included in the resource pool 20. When a new node is added, an entry is added to the node configuration table 501, while when the node is deleted, the entry is deleted so that registration information is updated in accordance with a change in the node configuration. For example, the management program 121 obtains node information from the node and updates the table 501. An administrator updates the node configuration table 501 by using the input/output device 15.

In the example in FIG. 6, the node configuration table 501 has a node ID column 601, a configuration physical resource column 602, and a value column 603. The node ID column 601 stores an identifier which uniquely identifies a node managed in the resource pool 20. The configuration physical resource column 602 defines a plurality of items specifying the physical resources (hardware resources) of each node. The value column 603 stores a value of each attribute item of the configuration physical resource column 602.

The configuration physical resource column 602 defines one or a plurality of attribute items of each physical device of devices such as a CPU, a memory, a storage device, an I/O device, an accelerator and the like, for example. They include attribute items such as “type” and “the number of cores” of the CPU and the “capacity” of the memory, and the node with the node ID “1” has 20 cores of the CPU, and the memory capacity is 128 GB.

In the example of FIG. 6, the attribute items of the storage device are defined for each type of storage devices. In the example of FIG. 6, the node with the node ID “1” (node 1) includes storage devices of the types of SSD-A, SSD-B, HDD-A and the like.

In the attribute items of the storage device, the “number” refers to the number of implemented storage devices of that type. The “Interconnect” refers to the connecting method (interface) of the storage device. The “division function” refers to the division function of the storage device, and SSD-A has an SR-IOV (Single Root I/O Virtualization) function, for example.

The “sharing” refers to another node which can directly access the storage device. A flash storage A can be accessed by a node with a node identifier “2” (node #2), for example. The node #2 can take over data of the flash storage A of the node with a node identifier “1” (node #1) at occurrence of a failure.

In the example of FIG. 6, the attribute items of the I/O device are defined for each type of the I/O devices. In the Example in FIG. 6, the node #1 includes an I/O device of a type of CNA-A or the like. In the attribute items of the I/O device, the “number of ports” refers to the number of physical ports of the I/O device, and the “performance” refers to data transfer performance of the port of the I/O device.

The attribute items of the accelerator are defined for each type of the accelerators. In the example of FIG. 6, a Graphics Processing Unit (GPU) which is one type of the accelerator of the node #1 is exemplified.

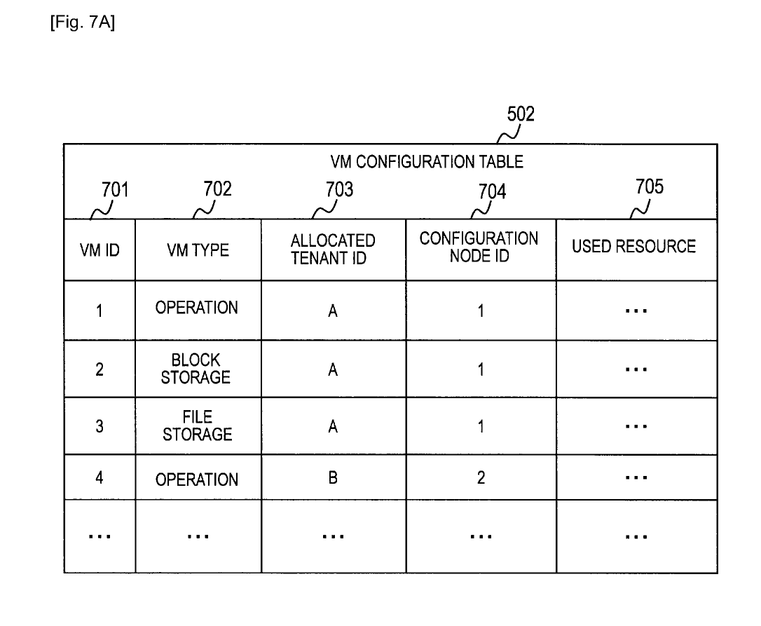

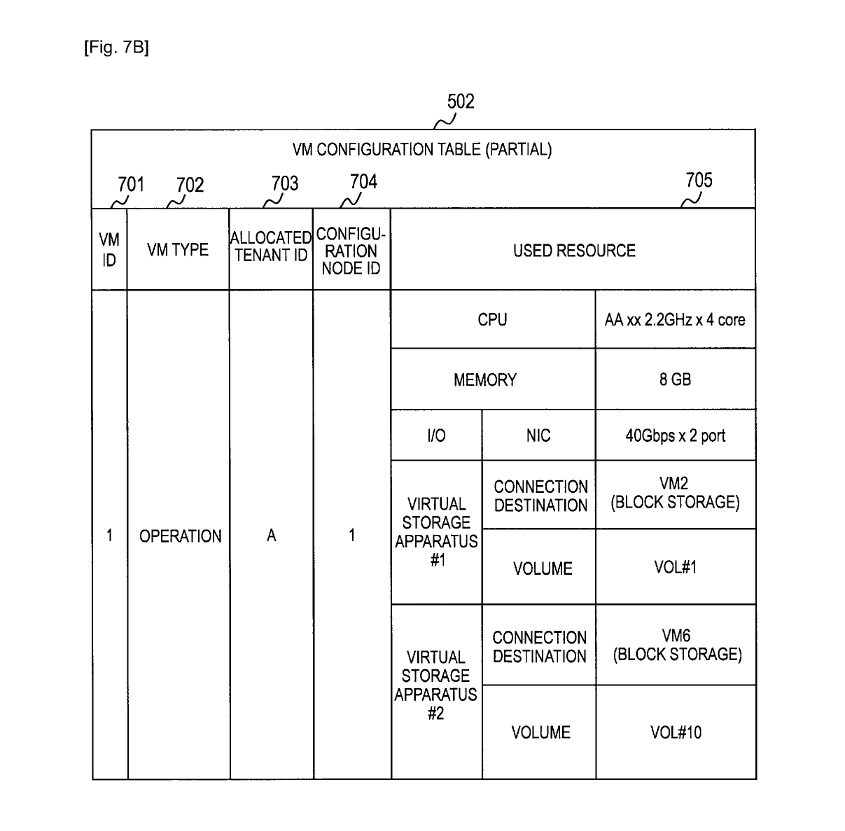

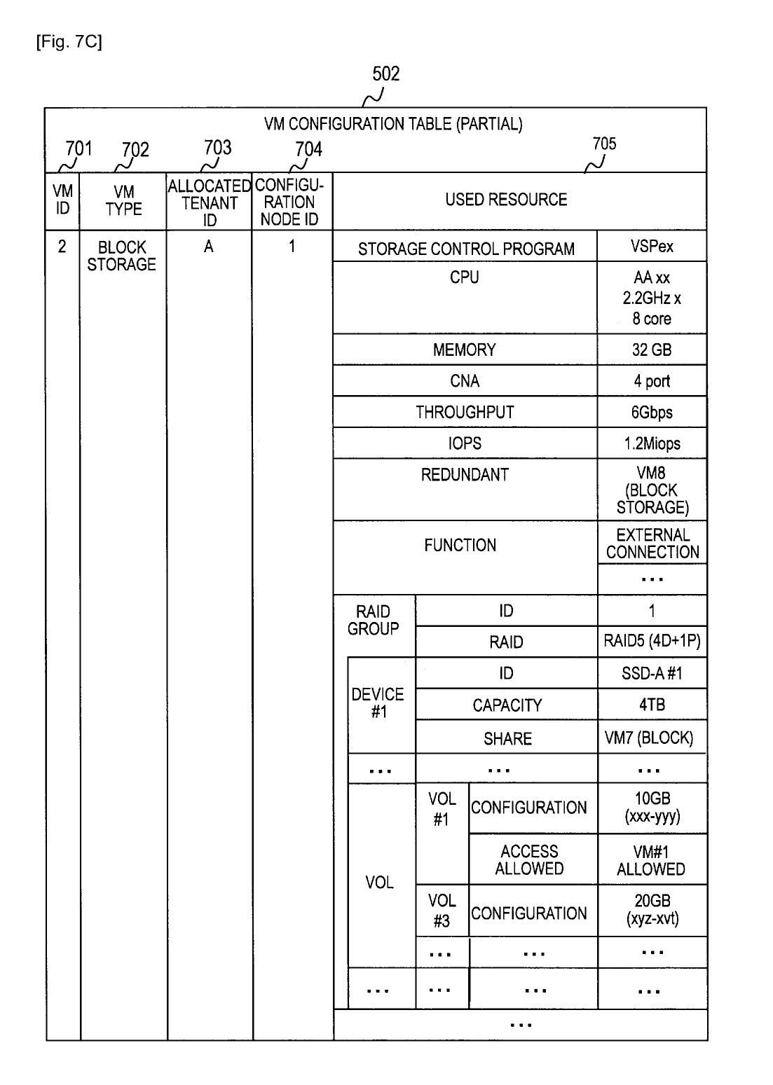

FIGS. 7A to 7C illustrate a configuration example of the VM configuration table 502.

The VM configuration table 502 is a table managing the VM configured on the node of the resource pool 20. If the VM is created, deleted or changed in the configuration in the resource pool 20, the VM configuration table 502 is updated. The storage provisioning program 403, the operation provisioning program 405, and the physical resource release program 407 update the VM configuration table 502.

FIG. 7A illustrates an entire configuration of partially omitted VM configuration table 502, and FIGS. 7B and 7C illustrate configuration information of the VM with the VMID “1” (VM #1) and configuration information of the VM with the VMID “2” (VM #2), respectively. The VM configuration table 502 has a VMID column 701, a VM type column 702, an allocated tenant ID column 703, a configuration node ID column 704, and a used resource column 705 as illustrated in FIG. 7A.

The VMID column 701 stores an identifier of each of the managed VMs. The VMID is unique in the resource pool 20. The VM type column 702 stores the type of each VM. The “operation” VM is a VM in which an application used for an operation is operated, the “block storage” VM is a VM operated as a block storage apparatus, and the “file storage” VM is a VM operated as a file storage apparatus.

The allocated tenant ID column 703 stores an identifier of a tenant to which each VM is allocated. The configuration node ID column 704 stores an identifier of a node in which each VM is configured. The used resource column 705 stores information of resources (including hardware resources and software resources) used by each VM.

As illustrated in FIG. 7B, the type of the VM #1 is “operation”, the allocated tenant ID is “A”, and the node ID where it is configured is “1”. The hardware resource this VM #1 uses on (is allocated to) the node #1 is a CPU core, a memory, and an NIC.

The CPU type used by the VM #1 is “AAxx2.2 GHz”, and 4 CPU cores are used. Moreover, the VM #1 uses the “8 GB” memory and two 40 Gbps NIC ports.

This operation VM (VM #1) further uses two virtual storage apparatuses for saving data (user data). The VM identifier of one virtual storage apparatus #1 (identifier “1” unique in the VM) is “2” and its type is “block storage”. This operation VM (VM #1) accesses a volume with the identifier “1” (“VOL #1”) provided by the virtual storage apparatus #1. This volume identifier is unique in the virtual storage apparatus #1.

The VM identifier of the other virtual storage apparatus #2 is “6” and its type is “block storage”. This operation VM (VM #1) accesses a volume with the identifier “10” (“VOL #10”) provided by the virtual storage apparatus #2. This volume identifier is unique in the virtual storage apparatus #2.

As illustrated in FIG. 7C, the type of the VM #2 is “block storage”, the allocated tenant ID is “A”, and the node ID where it is configured is “1”. The item of the used resource information of the virtual storage apparatus (VM of the block storage and the file storage) is different from the information item of the operation VM.

Specifically, in the example of FIG. 7C, the hardware resource (logical device) that the virtual block storage apparatus (VM #2) uses on (is allocated to) the node #1 is a CPU core, a memory, a CNA and a storage device. In this example, a RAID group is configured.

The CPU type used by the virtual block storage apparatus (VM #2) is “AAxx2.2 GHz”, and 8 CPU cores are used. Moreover, the virtual block storage apparatus (VM #2) uses the “32 GB” memory and four 40 Gbps CNA ports. The virtual block storage apparatus (VM #2) has performance of 6 Gbps throughput and 1.2 Miops.

The virtual block storage apparatus (VM #2) is redundant, and the redundant virtual block storage apparatus is configured on the VM with the VMID “8”. The configurations of these virtual block storage apparatuses are typically the same in points other than the storage device. The redundant virtual block storage apparatus (VM #8) can access a storage device (data) of the original virtual block storage apparatus (VM #2).

In this example, the virtual block storage apparatus (VM #2) has a plurality of functions. Implemented functions depend on the program and version of the virtual block storage apparatus. FIG. 7C exemplifies an external connection function.

The external connection function is a function of handling a plurality of storage apparatuses of the same model or different models as one storage apparatus by mapping a logical volume (storage device) of the external storage apparatus connected by a specific interface (protocol) such as FC. The connected external storage apparatus is virtualized, and the block storage apparatus can operate and manage the storage device of the external storage apparatus similarly to its built-in storage device and enables data copying between them.

The virtual block storage apparatus (VM #2) includes a plurality of RAID groups, and information of one RAID group is exemplified in FIG. 7C. The identifier of this RAID group is “1” (RAID group #1), and this identifier is unique in the virtual block storage apparatus. The RAID type is RAID 5, and storage regions of five storage device are included.

The whole storage region or a part of the storage region of one storage device is allocated to the virtual block storage apparatus in accordance with the logical partitioning program and the function of the storage device as well as performance required for the virtual block storage apparatus. In the example of FIG. 7C, all the storage regions (full capacity) of one storage device are allocated to the virtual block storage apparatus “2”.

FIG. 7C exemplifies information of one storage device (storage device #1) in the RAID group #1. In this example, this identifier of the storage device is unique in the RAID group. As described above, the RAID group #1 includes four other storage devices.

The exemplified storage device #1 is the “SSD-A#1”. This means the storage device with the identifier of “1” in the storage device of the “SSD-A” type. The capacity (capacity allocated to the virtual block storage apparatus (VM #2) in this example) is 4 TB. The storage device #1 is shared by the virtual block storage apparatus of the VM #7 (can be accessed by the VM #7).

The RAID group #1 includes volumes such as volumes #1, #3 and the like. For example, the capacity of the volume #1 is 10 GB, and a starting address is “xxx-yyy”. The VM configuration table 502 includes information of access permission to the volume (information specifying accessible VM), and the VM capable of accessing the volume #1 is VM #1 in the example of FIG. 7C.

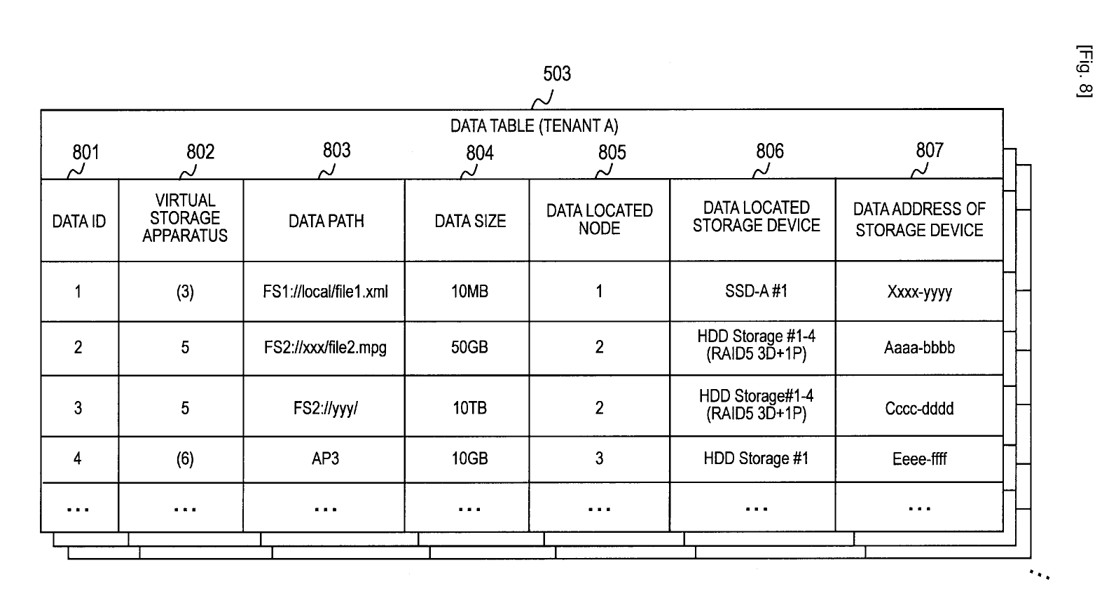

FIG. 8 illustrates a configuration example of the data table 503. The data table 503 maintains location information of the data. The data table 503 is prepared at each tenant, and each data table 503 manages data of each tenant. As a result, the tenant is prevented from accessing data of another tenant, and security can be ensured.

The data table 503 is updated at resource allocation, resource release, file creation, data volume creation and the like, for example. The physical resource release program 407 and the administrator update the data table 503.

FIG. 8 exemplifies contents of the data table 503 of a tenant A. Management of the data of the plurality of tenants may be executed by using one table, and the number of tables depends on the design. This point also applies to the other tables. In this example, the data table 503 has a data ID column 801, a virtual storage apparatus column 802, a data path column 803, a data size column 804, a data located node column 805, a data located storage device column 806, and a data address column 807 of storage device.

The data ID column 801 stores a unique data identifier at each tenant. The virtual storage apparatus column 802 stores the VMID of the virtual storage apparatus storing the data. The VMID in the parentheses means that the virtual storage apparatus has been already erased (the resources have been released). The data path column 803 stores an application ID which uses (used) a data path of the data or data. The data size column 804 and the data located node column 805 store the data size and the located node ID, respectively.

The data located storage device column 806 stores an identifier of the storage device storing the data, and if the data is stored in the RAID group, the column stores the identifier of the storage device constituting it. The data address column 807 stores a starting address of a region where the data is stored.

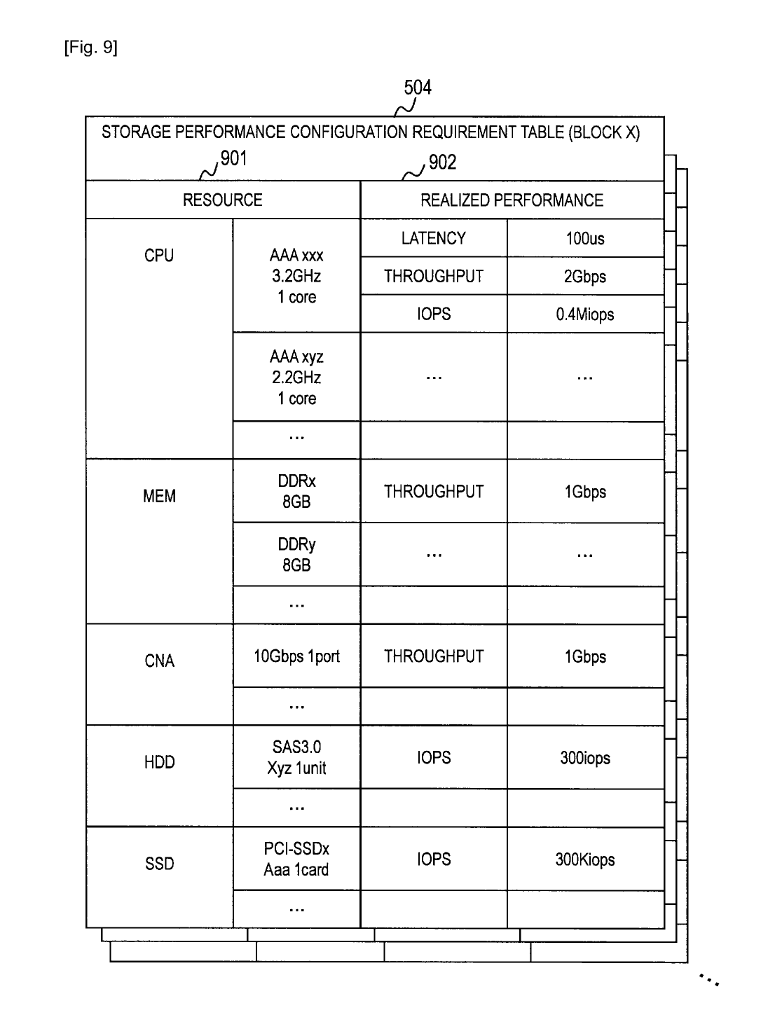

FIG. 9 illustrates a configuration example of the storage performance configuration requirement table 504 holding resource requirements for constituting a storage provided with desired performance. The storage performance configuration requirement table 504 holds information of performance each resource can exert in the virtual storage apparatus. The information on the table is provided as additional information of the block storage control program and the file storage control program, and a tool program for the management program or an information import function of the management program updates this table. The administrator also can input data to create and update the storage performance configuration requirement table 504 by using the input/output device 15.

The storage performance configuration requirement table 504 is prepared for a virtual storage apparatus realized by each storage control program, and each storage performance configuration requirement table manages the performance configuration requirement information of each virtual storage apparatus. If the type (block storage or file storage), model or version of the virtual storage apparatuses (storage control programs) is different, they are different virtual storage apparatuses.

FIG. 9 exemplifies contents of the storage performance configuration requirement table 504 of a virtual block storage apparatus X (block storage control program X). The storage performance configuration requirement table 504 has a resource column 901 and a realized performance column 902.

The resource column 901 stores information of class, type, and unit (quantity, capacity and the like) of a hardware resource (physical device) that is capable of realizing, that is, required for realizing a predetermined performance value of the virtual storage apparatus. The realized performance column 902 stores the predetermined performance value that can be realized by the virtual storage apparatus. In order to satisfy the required performance of the virtual storage apparatus, the realizable performance value of each device needs to satisfy the performance requirements of the virtual storage apparatus, and the realizable performance values of each device can be added together.

In the example in FIG. 9, the storage performance configuration requirement table 504 stores performance information of the device such as a CPU, a memory (MEM), an CNA, an HDD, an SSD and the like. 1 core of the CPU of the type “AAAxxx3.2 GHz” can realize latency 100 us, throughput 2 Gbps, and 0.4 Miops, for example.

The performance value realizable by the CPU core is in proportion to the number of cores. 2 cores of the CPU of the type “AAAxxx3.2 GHz” can realize latency 50 us, throughput 4 Gbps, and 0.8 Miops, for example.

8 GB of the memory of the type “DDRx” can realize throughput 1 Gbps. In order to realize throughput 2 Gbps by using the “DDRx” memory, 16 GB or more is required.

Moreover, one HDD unit (drive) of the type “SAS3.0Xyz” realizes performance of 300 iops and one SSD card (drive) of the type “PCI-SSDxAaa” can realize performance of a virtual storage apparatus having 300 Kiops. These performance values can be also added.

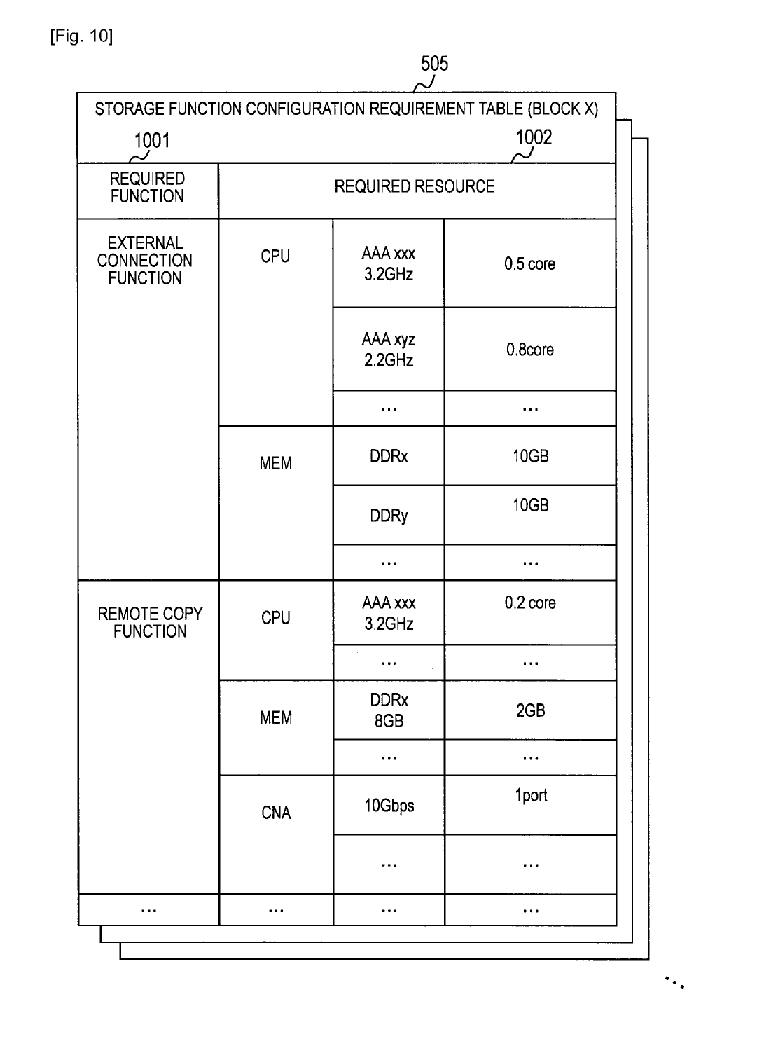

FIG. 10 illustrates a configuration example of the storage function configuration requirement table 505. The storage function configuration requirement table 505 maintains resource requirements for constituting a virtual storage apparatus provided with desired functions. The administrator creates and updates the storage function configuration requirement table 505 by using the input/output device 15.

The storage function configuration requirement table 505 is prepared for a virtual storage apparatus realized by each storage control program, and each of the storage function configuration requirement tables 505 manages the function configuration requirement information of each virtual storage apparatus. FIG. 10 exemplifies contents of the storage function configuration requirement table 505 of a virtual block storage apparatus X (block storage control program X).

The storage function configuration requirement table 505 has a requested function column 1001 and a required resource column 1002 and manages hardware resources required for realizing registered functions.

FIG. 10 exemplifies resource requirements required for the external connection function and the remote copying function. In order for the virtual block storage apparatus X to implement the external connection function, for example, 0.5 core of the “AAAxxx3.2 GHz” CPU and 10 GB of the “DDRx” memory (MEM) are required. In order to satisfy both the desired performance and desired functions, the hardware resources of the virtual storage apparatus need to include resources added with the respective required resources.

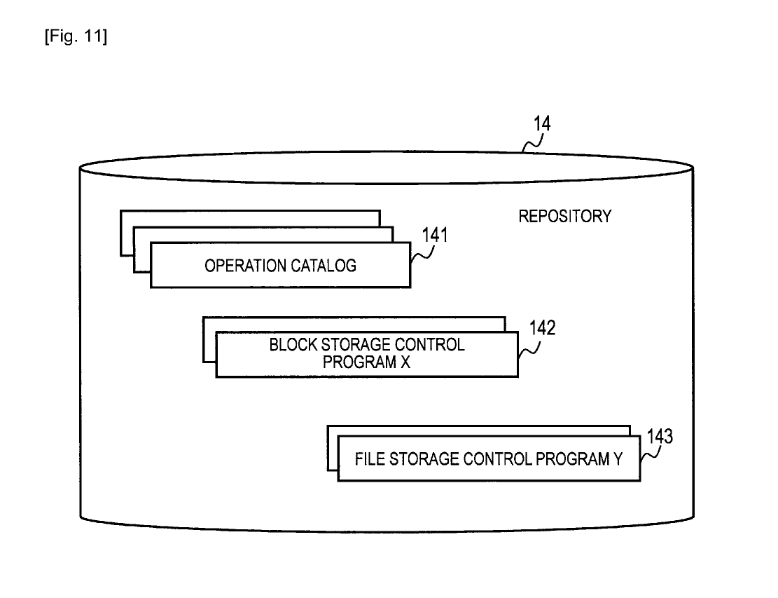

FIG. 11 exemplifies programs (software) included in the software repository 14. In this example, the repository 14 stores a plurality of operation catalogs 141, a plurality of block storage control programs 142, and a plurality of file storage control programs 143. The operation catalog 141 includes a program for realizing an operation or specifically includes programs for creating operation VMs such as an operation application program, an operating system, a middleware program and the like. The VM on which these programs operate functions as an operation VM.

The block storage control program 142 and the file storage control program 143 are control programs for realizing a virtual block storage apparatus and a virtual file storage apparatus, respectively. The repository 14 includes the block storage control programs 142 and the file storage control programs 143 with different types, models, versions and the like. The VMs on which these programs operate function as virtual storage apparatuses.

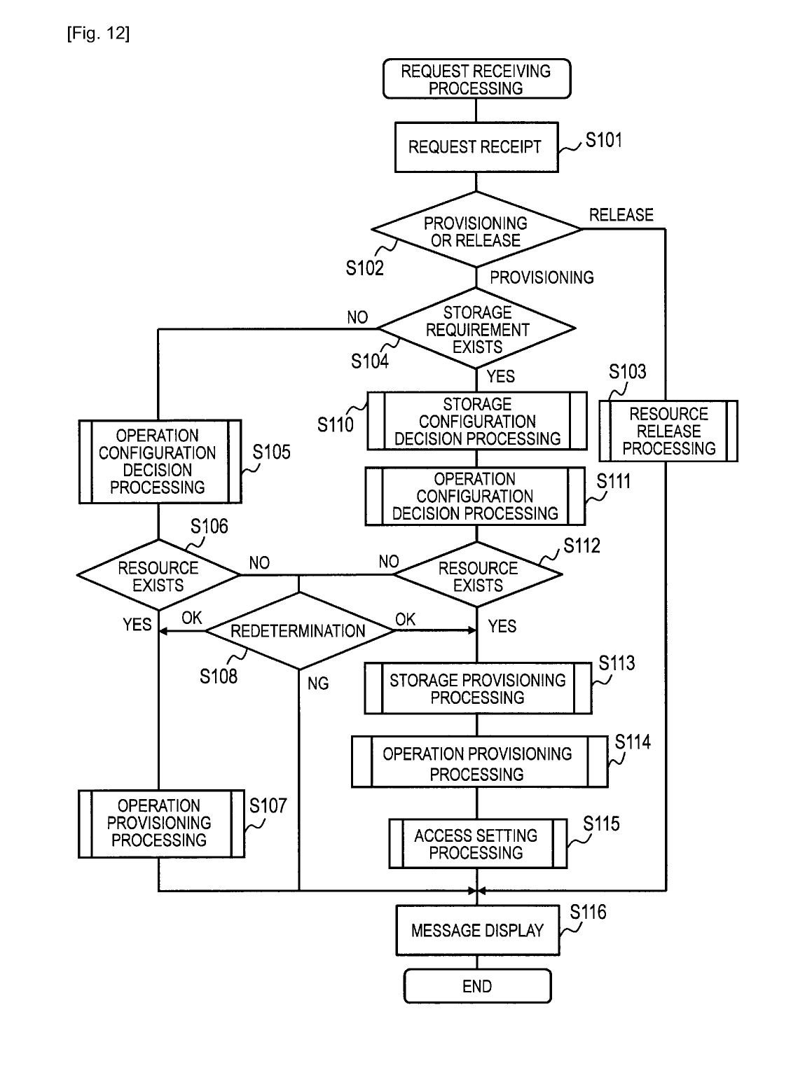

FIG. 12 is a flowchart illustrating a processing example by the request receiving program 401. The request receiving program 401 receives a request from the administrator and executes corresponding processing. First, the request receiving program 401 receives a request inputted from the input/output device 151 (S101) and determines the request contents.

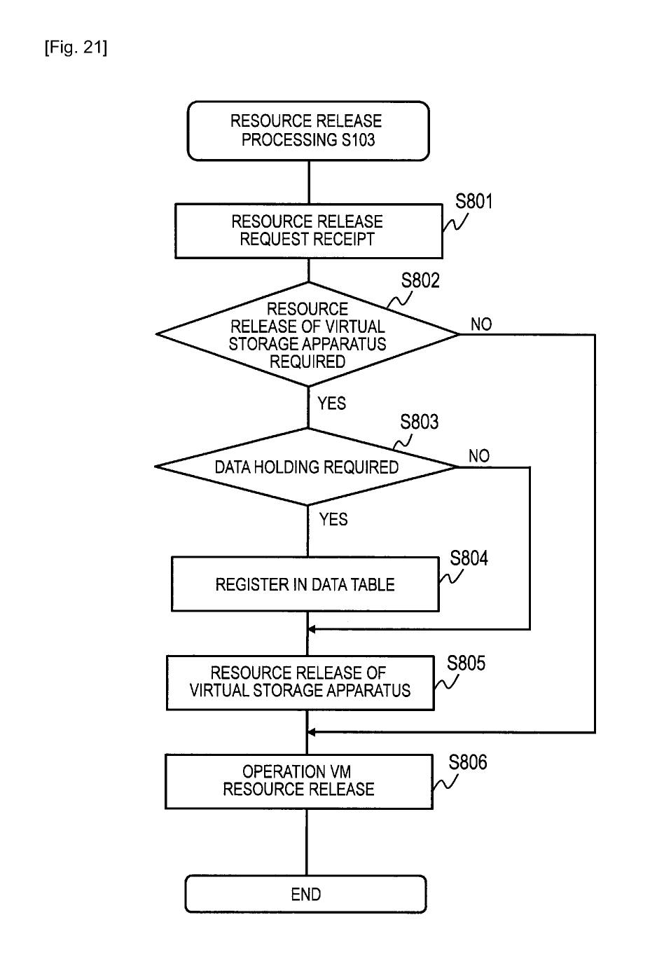

In this example, the request receiving program 401 determines if the request is provisioning (creation of a new operation VM and/or a virtual storage apparatus) or release of a hardware resource (deletion of an operation VM and/or a virtual storage apparatus) (S102). If the request is release of a hardware resource (S102: Release), the physical resource release program 407 instructed by the request receiving program 401 executes resource release processing (S103). The resource release processing 5103 will be described later by referring to FIG. 21.

If the request is provisioning (S102: Provisioning), the request receiving program 401 determines whether or not the request includes a request for provisioning of a virtual storage apparatus (storage requirement) (S104). If there is no storage requirement (S104: NO), the operation configuration determining program 404 instructed by the request receiving program 401 executes operation configuration decision processing (S105).

After that, the request receiving program 401 determines if there is a hardware resource satisfying the determined operation configuration by referring to a processing result of the operation configuration determining program 404 (S106). If the hardware resource is not sufficient, the request receiving program 401 obtains a notice to the effect from the operation configuration determining program 404.

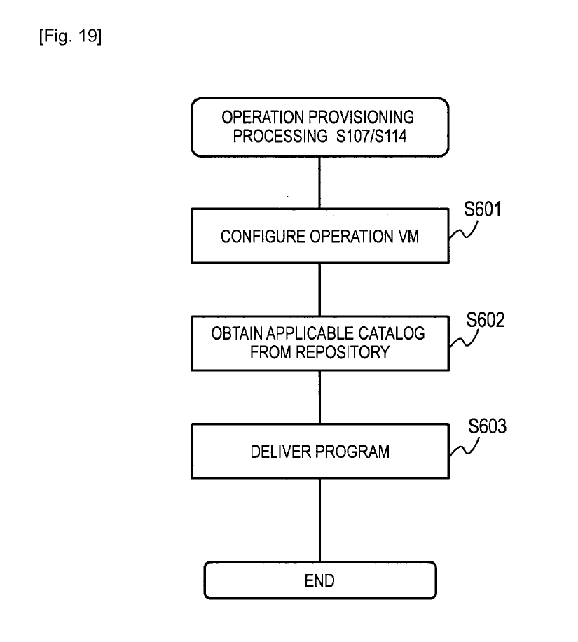

If there is a hardware resource which enables operation configuration (S106: YES), the operation provisioning program 405 instructed by the request receiving program 401 executes operation provisioning processing (S107). The operation provisioning processing S107 will be described later by referring to FIG. 19.

If there is no hardware resource which enables operation configuration (S106: NO), the request receiving program 401 examines available transfer of the operation VM and the virtual storage apparatus and re-determines if the operation configuration can be realized by the resulting available hardware resource (S108). Specifically, the operation configuration determining program 404 executes operation configuration decision processing for the configuration after the transfer and the request receiving program 401 refers to the result.

If the determination result is positive (S108: OK), the flow proceeds to Step S107, while if the determination result is negative (S108: NG), the request receiving program 401 outputs a message to the effect to the input/output device 151 (S116). This Step S108 may be omitted.

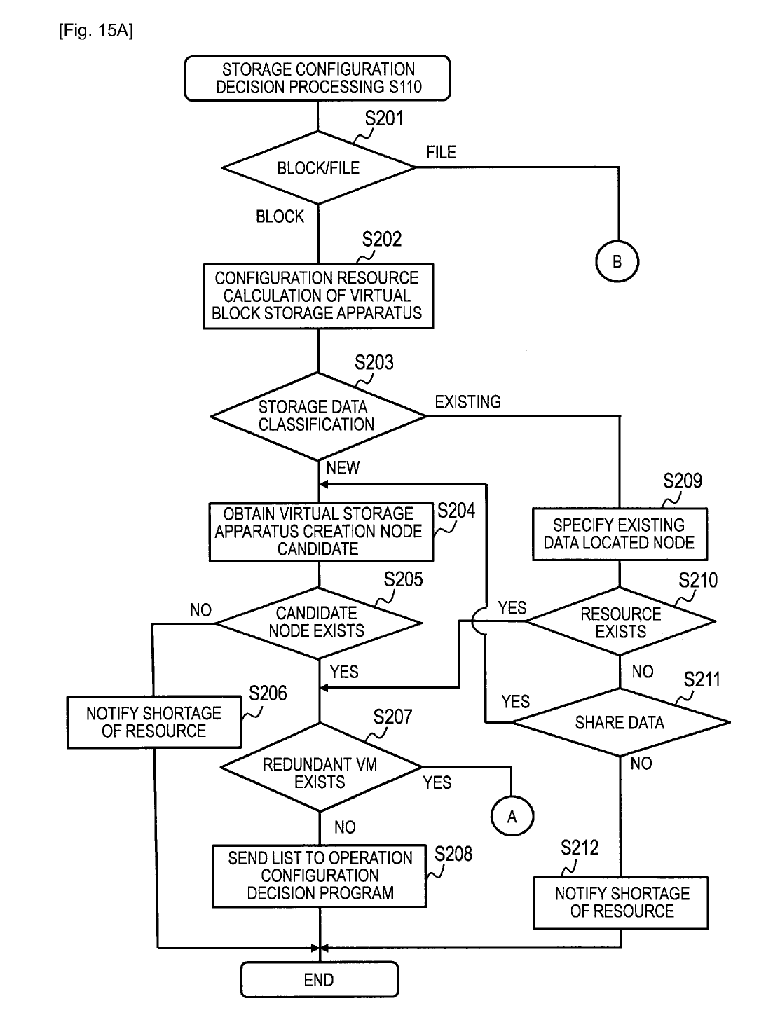

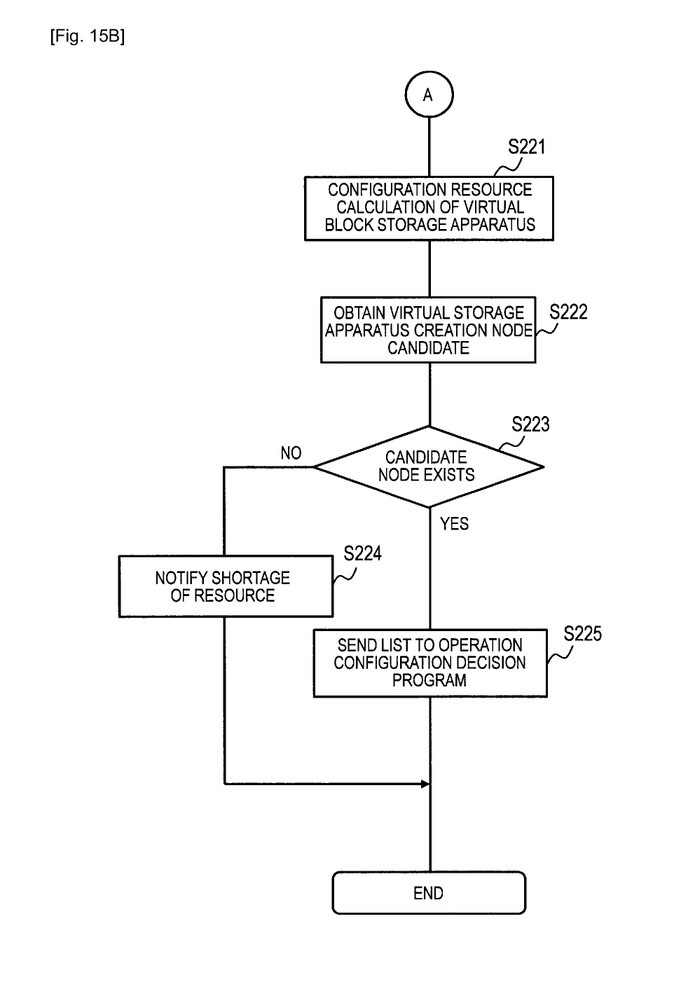

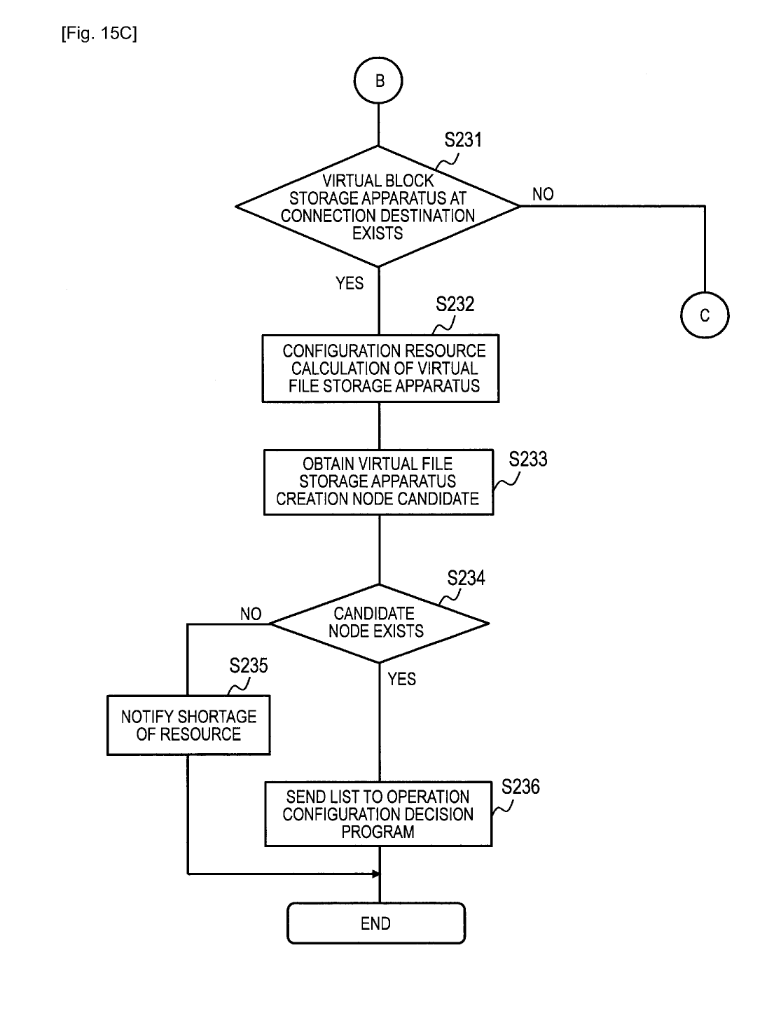

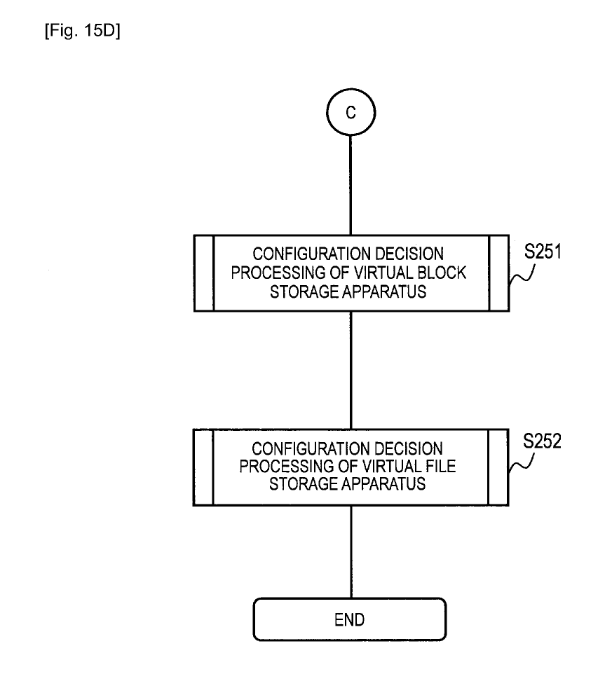

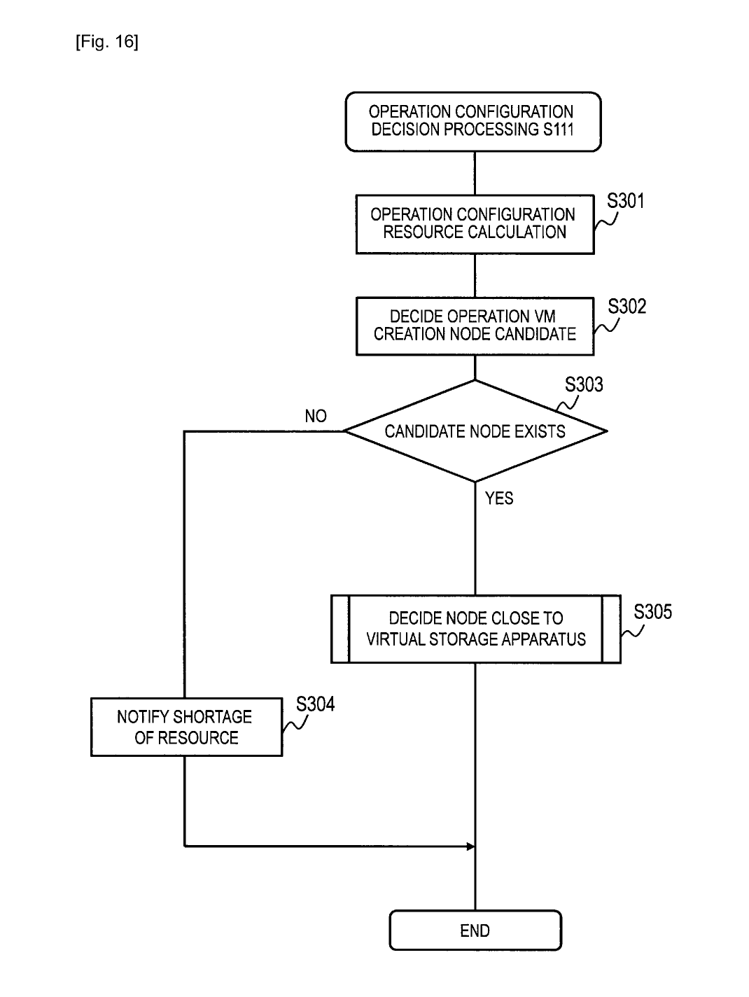

If there is a storage requirement at Step S104 (S104: YES), the storage configuration determining program 402 instructed by the request receiving program 401 executes storage configuration decision processing (S110). The storage configuration decision processing S110 will be described later by referring to FIGS. 15A to 15D. Moreover, the operation configuration determining program 404 instructed by the request receiving program 401 executes operation configuration decision processing (S111). The operation configuration decision processing S111 will be described later by referring to FIG. 16.

After that, the request receiving program 401 determines whether or not there is a hardware resource satisfying the determined storage configuration and operation configuration by referring to the processing results of the storage configuration determining program 402 and the operation configuration determining program 404 (S112). If the hardware resource is not sufficient, the request receiving program 401 obtains the notice to the effect from the storage configuration determining program 402 and/or the operation configuration determining program 404.

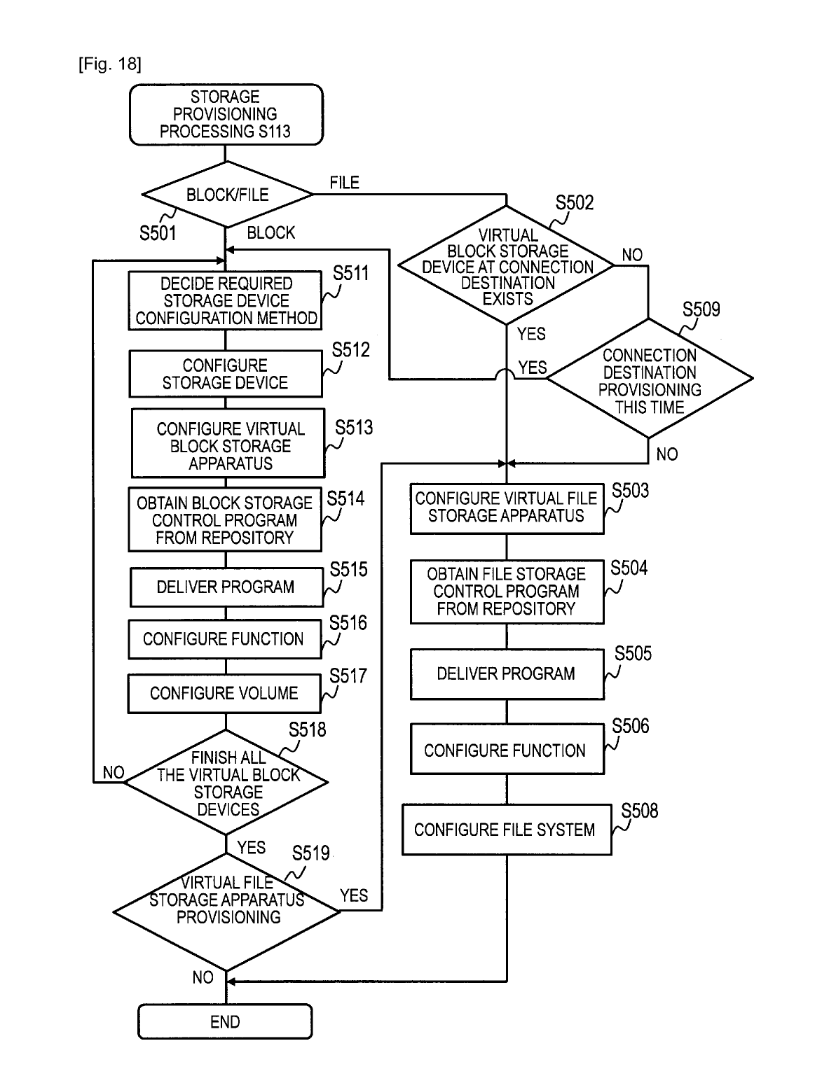

If the hardware resource which enables storage configuration and operation configuration is not sufficient (S112: NO), the flow proceeds to Step S108. At Step S108, the storage configuration decision processing and the operation configuration decision processing are executed for the configuration after the transfer of the VM. If there is a hardware resource which enables storage configuration and the operation configuration (S112: YES), the storage provisioning program 403 instructed by the request receiving program 401 executes storage provisioning processing (S113). The storage provisioning processing S113 will be described later by referring to FIG. 18.

Moreover, the operation provisioning program 405 instructed by the request receiving program 401 executes operation provisioning processing (S114). The operation provisioning processing S114 is similar to the operation provisioning processing S107 and will be described later by referring to FIG. 19.

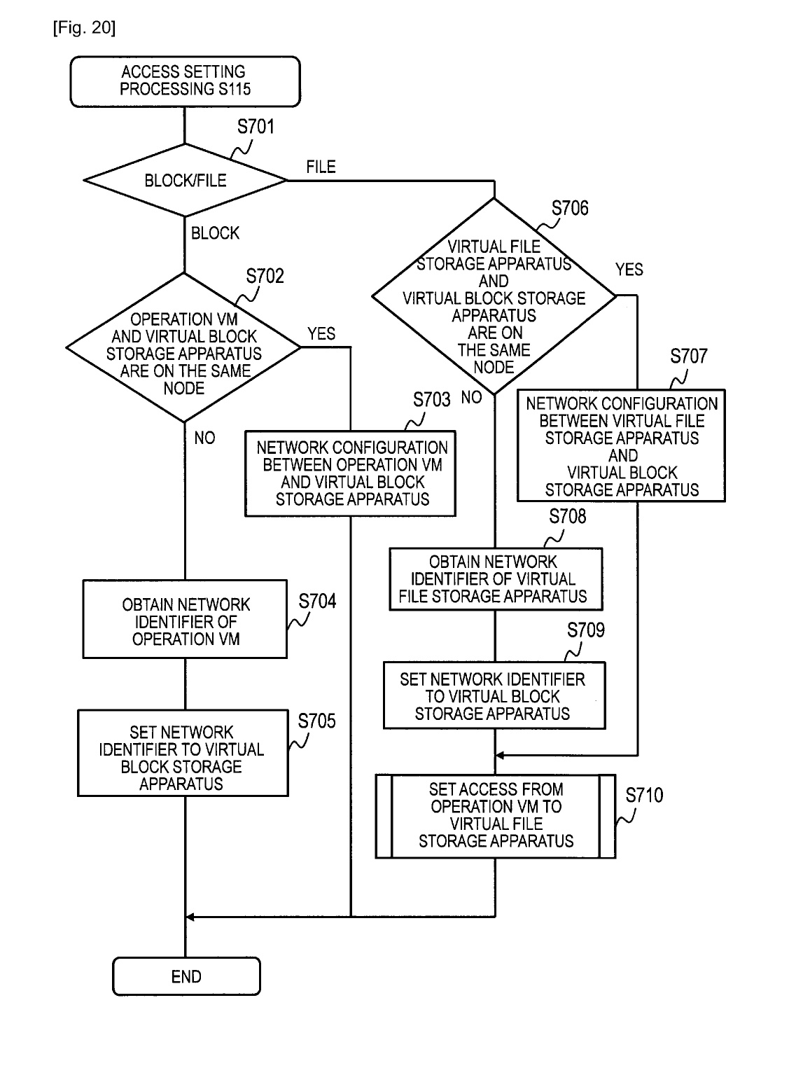

After that, the access setting program 406 instructed by the request receiving program 401 executes access setting processing (S115). The access setting processing S115 will be described later by referring to FIG. 20. The request receiving program 401 outputs a message of the configuration result (including a failed configuration result due to insufficient resource) to the input/output device 151 (S116) and finishes the processing.

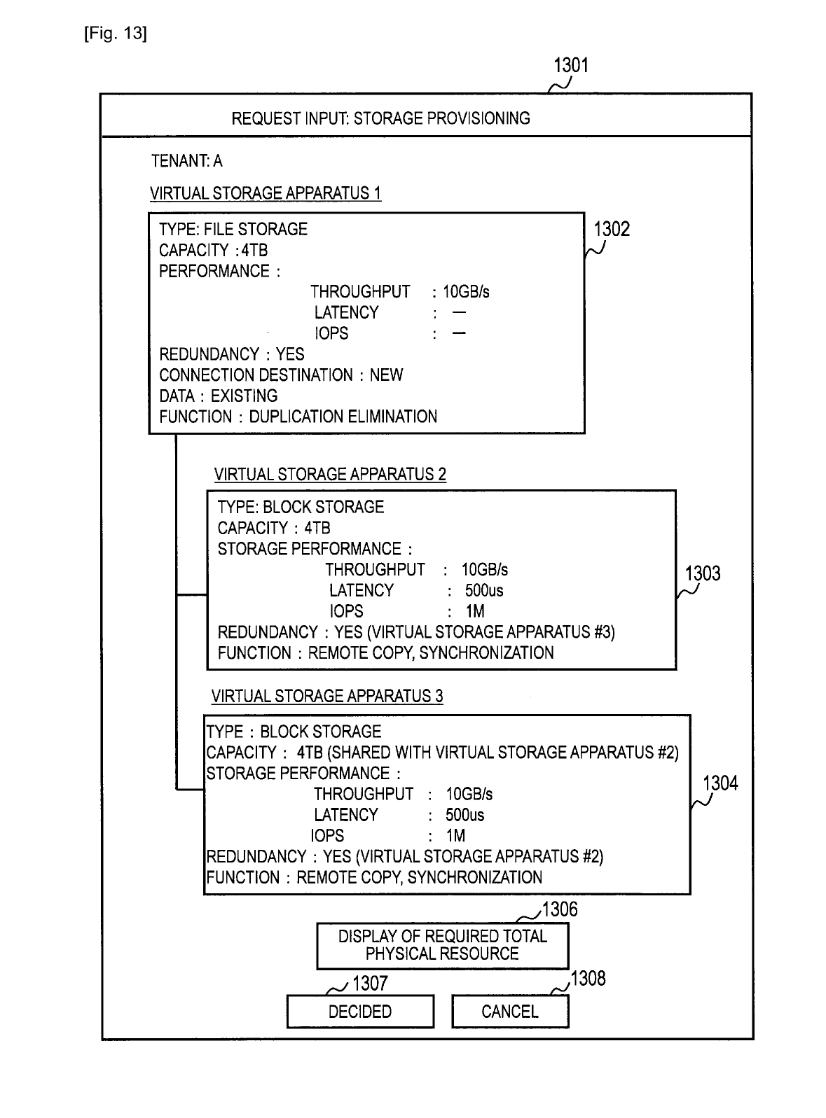

FIG. 13 illustrates an example of a GUI image 1301 for making a request of storage provisioning. In this example, provisioning of a virtual block storage apparatus used by the virtual file storage apparatus and the virtual file storage apparatus used by the tenant A is requested. As illustrated in this example, the administrator can specify configuration conditions 1302 to 1304 including performance and functions of the virtual storage apparatus for which provisioning is requested by using the input/output device 151.

The administrator can specify the type of the virtual storage apparatus (block storage/file storage), the capacity of the virtual storage apparatus, the performance of the virtual storage apparatus (throughput, latency, IOPS and the like), and functions (external connection function, remote copying function and the like) and the like.

Moreover, regarding the provisioning of the virtual file storage apparatus, whether a virtual block storage apparatus to be connected is to be newly created or an existing virtual block storage apparatus is to be used or the like can be specified. Regarding the provisioning of the virtual block storage, whether the RAID configuration and the virtual block storage apparatus are set to be redundant, existing data is to be included in the virtual block storage apparatus to be created and the like can be specified.

The items that can be specified and requested by the administrator may depend on system design, and a part of the above-described items or requirements different from them may be specified. For example, the administrator may be able to specify the number of simultaneously created virtual storage apparatuses with the same configuration.

As indicated by the configuration condition 1302, redundancy of the virtual block storage apparatus is requested in this example, and a virtual storage apparatus 3 is a redundant VM of a virtual storage apparatus 2, and their configurations are the same except that the storage device of the virtual storage apparatus 2 is shared. The virtual block storage apparatus to which the virtual file storage apparatus is to be connected is requested to be newly created (provisioned).

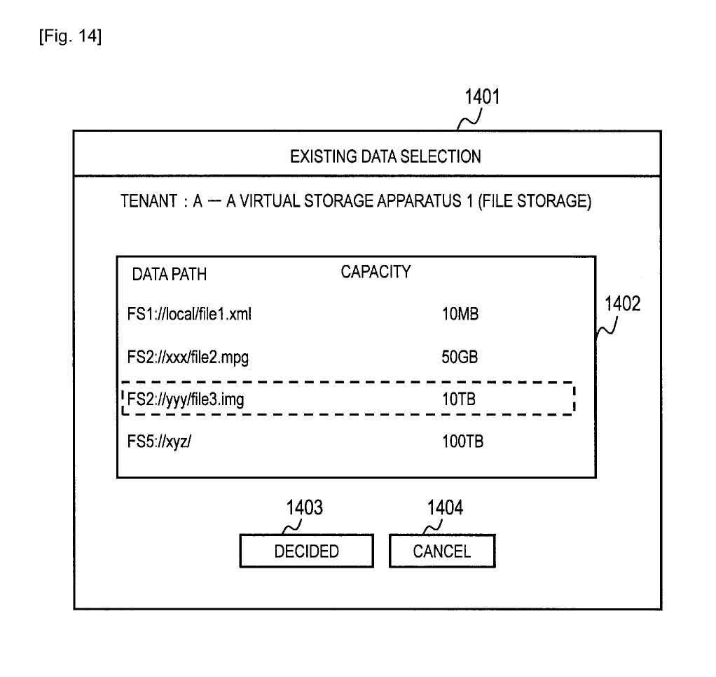

An access to existing data by the virtual file storage apparatus is requested. Selection of the existing data will be described later by referring to FIG. 14. As a function of the virtual file storage apparatus, implementation of duplication eliminating function is requested.

The request receiving program 401 may automatically determine the configuration condition of a required virtual block storage apparatus in compliance with the configuration condition 1302 of the virtual file storage apparatus inputted by the administrator and display it. The request receiving program 401 can determine required configuration conditions of the virtual block storage apparatus from the requested configuration conditions of the virtual file storage apparatus by referring to management information (not shown) which associates the configuration condition of the file storage apparatus with the configuration condition of the block storage apparatus.

The administrator can have the request receiving program 401 display the physical resource required for provisioning of the specified virtual storage apparatus by selecting “display of required total physical resources” 1306. The request receiving program 401 can specify the required resource by referring to the storage performance configuration requirement table 504 and the storage function configuration requirement table 505. If “decided” 1307 is selected, the configuration condition is confirmed. The administrator can re-input the configuration condition by selecting “cancel” 1308.

FIG. 14 illustrates an example of a GUI image 1401 used by the administrator if the existing data is to be used in creation of the virtual storage apparatus (the virtual storage apparatus to be created accesses the existing data). The request receiving program 401 obtains information of the existing data from the data table 503 of the requesting tenant and displays a data list 1402.

The administrator can select data (data of file, directory, predetermined address area and the like) to be included in the virtual block storage apparatus to be created from the displayed data list 1402. The node that can access the storage device having the selected data is allocated to the virtual block storage apparatus to be created, and the block storage control program is implemented therein.

In the example of FIG. 14, the virtual storage apparatus 1 is requested to be allowed to access a file (data) of “FS2://yyy/file3.img”. If “decided” 1403 is selected, the existing data to be included is confirmed. The administrator can re-select the data by selecting “cancel” 1404.

FIGS. 15A to 15D are flowcharts illustrating an example of the storage configuration decision processing (S110). Information of the storage configuration to be decided is configuration information indicated in the VM configuration table 502 in FIG. 7C, for example, and the type (SSD/HDD and the like) and the number of storage devices, the type of I/O and the number of ports (paths), the number of paths to the storage device, the number of CPU cores, the memory capacity and the like to be allocated are decided.

In FIG. 15A, the storage configuration determining program 402 refers to the configuration condition of the virtual storage apparatus for which provisioning is requested and determines the type of the requested virtual storage apparatus (S201). If provisioning of the virtual file storage apparatus is requested (S201: File), the storage configuration determining program 402 proceeds to the flow in FIG. 15C through a connector B.

If provisioning of only the type of block storage is requested (S201: block), the storage configuration determining program 402 determines the configuration of each of the virtual block storage apparatuses for which provisioning is requested. In this example, provisioning of one virtual block storage apparatus or two virtual block storage apparatuses including a redundant virtual block storage apparatus is requested.

The storage configuration determining program 402 calculates a hardware resource required for configuration of an original virtual block storage apparatus which is not a redundant virtual block storage apparatus by referring to the storage performance configuration requirement table 504 and the storage function configuration requirement table 505 (S202).

Subsequently, the storage configuration determining program 402 determines classification of data the virtual block storage apparatus should store (S203). Specifically, it is determined whether or not the existing data has been selected as data to be stored by the virtual block storage apparatus (See FIGS. 13 and 14).

If the data to be stored is new data, that is, if existing data is not specified (S203: New), the storage configuration determining program 402 obtains a candidate node for creating the virtual block storage apparatus (S204). Specifically, the storage configuration determining program 402 refers to the node configuration table 501, selects all the nodes including available resources satisfying the configuration requirement of the virtual block storage apparatus and creates a list of them.

If there is no candidate node, the list for the virtual block storage apparatus is not created. Moreover, if there is no candidate node (S205: NO), the storage configuration determining program 402 notifies the resource shortage to the request receiving program 401 (S206).

If there is a candidate node (S205: YES), the storage configuration determining program 402 determines whether or not provisioning of the redundant virtual block storage apparatus is required (S207). If the determination result is negative (S207: NO), the storage configuration determining program 402 sends a candidate node list to the operation configuration determining program 404 (S208). If the determination result is positive (S207: YES), the program proceeds to the flow in FIG. 15B through a connector A.

If it is determined at Step S203 that the existing data is selected as data to be stored by the virtual block storage apparatus (S203: Existing), the storage configuration determining program 402 specifies the node where the existing data exists by referring to the data table 503 of the tenant (S209).

The storage configuration determining program 402 determines whether the specified node has an available hardware resource satisfying the configuration of the requested virtual block storage apparatus by referring to the node configuration table 501 and the VM configuration table 502 (S210). If there is an available hardware resource capable of constituting the requested virtual block storage apparatus (S210: YES), the storage configuration determining program 402 proceeds to Step S207. The specified node is entered in the candidate node list.

If there is no required available hardware resource (S210: NO), the storage configuration determining program 402 determines whether or not the virtual block storage apparatus this time implemented in another node can access the storage device storing the existing data (data sharing) (S211).

For example, if the existing data is managed by the virtual block storage apparatus and the virtual block storage apparatus this time has the external connection function, the determination 5211 is positive. Alternatively, if the existing data is stored in the storage device on the storage device aggregation node and there is a node which can directly access the storage device, the determination 5211 is positive. The storage configuration determining program 402 can know the management state of the existing data by referring to the data table 503. Moreover, the implementation function of the virtual block storage apparatus this time is specified by the user and its information is obtained from the request receiving program 401.

If the determination result is negative (S211: NO), the storage configuration determining program 402 notifies the resource shortage to the request receiving program 401 (S212). If the external connection function is not specified to the virtual block storage apparatus this time, the request receiving program 401 can promote the administrator to add a function by displaying a message to the effect.

If the determination result at Step S211 is positive (S211: YES), the storage configuration determining program 402 proceeds to Step S204 and obtains a candidate node having a required available resource from all the nodes accessible to the existing data, different from the node where the existing data exists.

Subsequently, configuration determination of the redundant virtual block storage apparatus will be described by referring to FIG. 15B. If configurations of a plurality of redundant virtual block storage apparatuses are to be determined, it is only necessary to execute this flow for each of the redundant virtual block storage apparatuses.

The storage configuration determining program 402 calculates a hardware resource required for configuration of the redundant virtual block storage apparatus by referring to the storage performance configuration requirement table 504 and the storage function configuration requirement table 505 (S221). Then, the storage configuration determining program 402 obtains a candidate node for creating the redundant virtual block storage apparatus (S222). The candidate node for the redundant virtual block storage apparatus is determined for each of the candidate nodes of original virtual block storage apparatus.

Specifically, the storage configuration determining program 402 refers to the result of the flow in FIG. 15A and the node configuration table 501 and selects all the nodes which are different from the candidate node for the original virtual block storage apparatus, include available resources satisfying the configuration requirement of the redundant virtual block storage apparatus and can refer to the storage device of the original virtual block storage apparatus.

For example, if the redundant virtual block storage apparatus includes the external connection function and is connected to the original virtual block storage apparatus via the network of a protocol supporting the external connection function (interface of the node), it can access the storage device of the original virtual block storage apparatus (capable of sharing of the storage device).

If there is no candidate node, a list for the redundant virtual block storage apparatus is not created. Moreover, if there is no candidate node (S223: NO), the storage configuration determining program 402 notifies the resource shortage to the request receiving program 401 (S224). If there is a candidate node (S223: YES), the storage configuration determining program 402 sends the candidate node list to the operation configuration determining program 404 (S225).

Subsequently, the configuration determination of the virtual file storage apparatus will be described by referring to FIGS. 15C and 15D. The flow in FIG. 15C illustrates a case in which only the configuration of the virtual file storage apparatus is determined and configuration determination of the virtual block storage apparatus is not necessary, and the flow in FIG. 15D is a case in which the configurations of both the virtual file storage apparatus and the virtual block storage apparatus connected to it are determined.

In the flow of FIG. 15C, the storage configuration determining program 402 determines whether or not the virtual block storage apparatus to which the requested virtual file storage apparatus is connected has been already determined (S231). If the determination result is negative (S231: NO), the storage configuration determining program 402 proceeds to the flow in FIG. 15D through a connector C.

If the determination result is positive (S231: YES), the storage configuration determining program 402 proceeds to Step S232. This is applicable to a case in which the user specifies the virtual block storage apparatus to be connected, for example. The storage configuration determining program 402 calculates a hardware resource required for the requested virtual file storage apparatus by referring to the storage performance configuration requirement table 504 and the storage function configuration requirement table 505 (S232).

The storage configuration determining program 402 obtains a candidate node for creating a virtual file storage apparatus (S233). Specifically, the storage configuration determining program 402 refers to the node configuration table 501, selects all the nodes including available resources satisfying the configuration requirement of the virtual file storage apparatus and creates a list of them.

If there is no candidate node, a list is not created. Moreover, if there is no candidate node (S234: NO), the storage configuration determining program 402 notifies the resource shortage to the request receiving program 401 (S235). If there is a candidate node (S234: YES), the storage configuration determining program 402 sends the candidate node list to the operation configuration determining program 404 (S236).

In the flow of FIG. 15D, the storage configuration determining program 402 executes the configuration decision processing 5251 of the virtual block storage apparatus and the configuration decision processing 5252 of the virtual file storage apparatus. The configuration decision processing 5251 of the virtual block storage apparatus follows the flows in FIGS. 15A and 15B, and the configuration decision processing 5252 of the virtual file storage apparatus follows the flow in FIG. 15C. In the configuration decision processing 5252 of the virtual file storage apparatus, the storage configuration determining program 402 determines a candidate node for a virtual file storage apparatus if the virtual block storage apparatus is arranged in each of the candidate nodes.

FIG. 16 is a flowchart illustrating an example of the operation configuration decision processing (S111). Information of the operation configuration to be decided is configuration information indicated in the VM configuration table 502 in FIG. 7B, for example. This flow includes provisioning of the virtual storage apparatus, but the flow of the operation configuration decision processing (S101) not including that is substantially the same except the determining processing of the provisioning of the virtual storage apparatus.

The operation configuration determining program 404 first calculates a hardware resource required for constituting the requested operation VM (S301). The condition required for requested configuration is inputted by the user or is defined in advance in the condition table (not shown) of the operation VM.

Subsequently, the operation configuration determining program 404 determines a candidate node for creating the requested operation VM (S302). In determination of the operation VM creation candidate node, the operation configuration determining program 404 refers to the candidate node for the virtual storage apparatus for which provisioning is requested and the information of the hardware resource in use (contents decided at Step S110) in addition to the node configuration table 501 and the VM configuration table 502.

If there are a plurality of candidate nodes for the virtual storage apparatus (a candidate for a group of a plurality of nodes for a plurality of virtual storage apparatuses), the operation configuration determining program 404 determines a candidate node for the operation VM available for each candidate.

If there is no candidate node for the operation VM (S303: NO), the operation configuration determining program 404 notifies the resource shortage to the request receiving program 401 (S304). If there is a candidate node for the operation VM (S303: YES), the operation configuration determining program 404 executes decision processing of node close to virtual storage apparatus (S305).

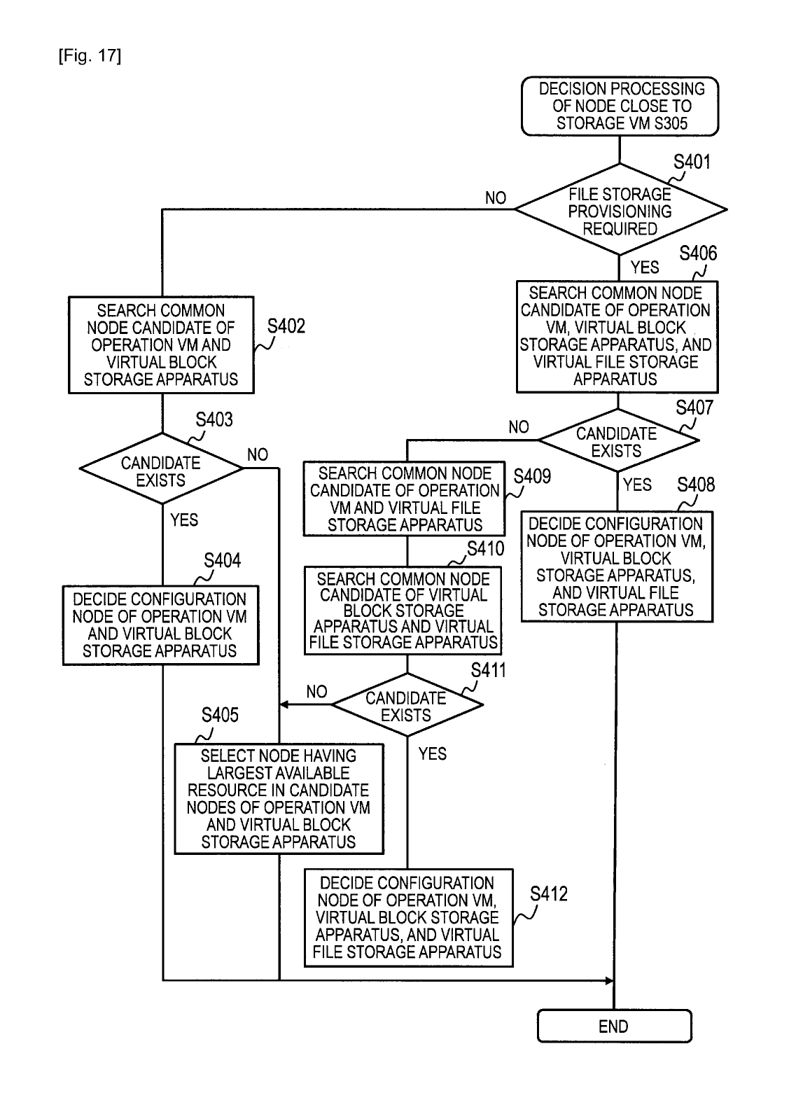

FIG. 17 is a flowchart illustrating an example of the decision processing 5305 of node close to virtual storage apparatus. This processing can determine a node to which the VM (including a virtual storage apparatus) is allocated so that the performance of data access by the operation VM (represented by latency and IOPS) becomes high. Here, one virtual block storage apparatus is assumed to be created with creation of the virtual file storage apparatus.

The operation configuration determining program 404 determines whether or not provisioning of the virtual file storage apparatus is required (S401). If it is not required (S401: NO), the operation configuration determining program 404 searches a common candidate node of the operation VM and the virtual block storage apparatus in a list of the candidate nodes of the virtual block storage apparatus and the operation VM (S402).

If there is a common candidate node (S403: YES), the operation configuration determining program 404 determines the common candidate node as a node on which the operation VM and the virtual block storage apparatus operate (S404). If there is no common candidate node (S403: NO), the operation configuration determining program 404 selects a node with the largest quantity of available resources in the candidate nodes for each of the operation VM and the virtual block storage apparatus (S405).

If the operation configuration determining program 404 determines at Step S401 that provisioning of the virtual file storage apparatus is required (S401: YES), it searches a common candidate node for them in the list of candidate nodes for the virtual file storage apparatus, the virtual block storage apparatus, and the operation VMs (S406). If all the VMs can be configured by the same candidate node (S407: YES), the operation configuration determining program 404 determines that three VMs are configured by the candidate node (S408).

If there is no common candidate node for the three VMs (S407: NO), the operation configuration determining program 404 searches a common candidate node for the operation VM and the virtual file storage apparatus (S409). Moreover, the operation configuration determining program 404 searches a common candidate node for the virtual file storage apparatus and the virtual block storage apparatus (S410).

If there is a common candidate node for the operation VM and the virtual file storage apparatus (S411: YES), the operation configuration determining program 404 determines that they are configured by the same node and moreover, determines that the virtual block storage apparatus is configured on another node (S412). The node constituting the virtual block storage apparatus is a node having the largest quantity of available resources in the candidate node, for example.

If there is no common candidate node for the operation VM and the virtual file storage apparatus and there is a common candidate node for the virtual file storage apparatus and the virtual block storage apparatus (S411: YES), the operation configuration determining program 404 determines that the virtual file storage apparatus and the virtual block storage apparatus are configured on the same node and moreover, determines that the operation VM is configured on another node (S412). The node constituting the operation VM is a node having a largest quantity of available resources in the candidate node, for example.

If there is neither common candidate node for the operation VM and the virtual file storage apparatus nor common candidate node for the virtual file storage apparatus and the virtual block storage apparatus (S411: NO), the operation configuration determining program 404 selects a node with the largest quantity of available resources in the candidate node for each of the VMs (S405).

With this processing, the user data and the application accessing it can be arranged close to each other, and data access performance and processing performance can be improved. The method of determining a VM implemented node of this example can be applied to determination of only the node of the operation VM and the determination of only the node of the virtual storage apparatus. If the node of the operation VM is determined, the management program 121 preferentially selects a node of the operation VM in node determination of the virtual file storage apparatus and/or the virtual block storage apparatus, for example.

FIG. 18 is a flowchart illustrating an example of the storage provisioning processing S113. If the virtual storage apparatus executing provisioning includes the virtual file storage apparatus and the virtual block storage apparatus, the storage provisioning program 403 executes provisioning of the virtual block storage apparatus before provisioning of the virtual file storage apparatus. The storage provisioning processing S113 is based on the results of the configuration decision processing S110 and S111.

In the flowchart in FIG. 18, if provisioning of the virtual file storage apparatus needs to be executed (S501: File), the storage provisioning program 403 refers to the results of the storage configuration decision processing S110 and the operation configuration decision processing S111 and determines whether or not a virtual block storage apparatus to which the virtual file storage apparatus is to be connected already exists (if provisioning of the virtual block storage apparatus is required) (S502).

If there is a virtual block storage apparatus to be connected (S502: YES), the virtual storage apparatus to be provisioned is only the virtual file storage apparatus. The storage provisioning program 403 configures the virtual file storage apparatus in a node selected in the operation configuration decision processing 5111 (S503). This configuration processing sets a logical partition for operating the virtual file storage apparatus with the logical partition program. The logical division program creates a logical partition of an instructed hardware resource for operating the virtual file storage apparatus.

After that, the storage provisioning program 403 obtains the file storage control program 143 selected by the user through a request input or selected by the storage configuration determining program 402 from the repository 14 (S504) and delivers it to the node (S505).

The storage provisioning program 403 configures (sets) the function of the virtual file storage apparatus with the file storage control program 143 (S506). After that, the storage provisioning program 403 configures a file system in the virtual file storage apparatus (S508). These processes can be performed by setting the required configuration data for the file storage control program, which is similar to setting in a usual file storage apparatus, and detailed explanation will be omitted.

If there is no virtual block storage apparatus to be connected (S502: NO), the storage provisioning program 403 refers to the result of the storage configuration decision processing S110 and determines whether or not provisioning of the virtual block storage apparatus is to be executed in the processing this time (S509).

If the provisioning of the virtual block storage apparatus is not to be performed (S509: NO), the storage provisioning program 403 proceeds to Step S503. If the provisioning of the virtual block storage apparatus is to be performed (S509: YES), the storage provisioning program 403 proceeds to Step S511.

If the virtual file storage apparatus is not to be provisioned and the virtual block storage apparatus is to be provisioned (S501: Block) or if the virtual block storage apparatus to which the virtual file storage apparatus is to be connected is to be provisioned (S509: YES), the storage provisioning program 403 proceeds to Step S511.

At step S511, the storage provisioning program 403 first determines a required storage device configuration in the storage devices of the already selected node for provisioning of the virtual block storage apparatus. At this step, whether to use the division function of the storage device is determined, storage devices to be allocated are selected, and a portion to be used by the selected storage devices is determined.

Subsequently, the storage provisioning program 403 configures the storage device to be allocated (S512). This Step S512 make the setting in the node so that the logical partition program can recognize the storage device with the configuration determined at Step S511.

Moreover, the storage provisioning program 403 configures the virtual block storage apparatus (S513). At this Step S513, the logical partition for operating the virtual block storage apparatus is set with the logical partition program. The logical partition program creates a logical partition of an instructed hardware resource for operating the virtual block storage apparatus.

Subsequently, the storage provisioning program 403 obtains the block storage control program 142 selected by the user or by the storage configuration determining program 402 from the repository 14 (S514) and delivers it to the node (S515). The storage provisioning program 403 sets the function in the virtual block storage apparatus (S516) and moreover, configures the volume (S517).

If there remains a virtual block storage apparatus to be provisioned (S518: NO), the storage provisioning program 403 returns to Step S511. If all the virtual block storage apparatuses have been provisioned (S518: YES), when there is a virtual file storage apparatus to be provisioned (S519: EYS), the storage provisioning program 403 proceeds to Step S503, while if there is none (S519: NO), the program finishes the flow.

FIG. 19 is a flowchart illustrating an example of the operation provisioning processing S107/S114. The operation provisioning program 405 makes setting for configuring the operation VM for the logical partition program or the virtualization program in the node selected at the operation configuration decision processing S111 (S601). The operation provisioning program 405 obtains the operation catalog 141 from the repository 14 (S602) and delivers it to the node (S603).

FIG. 20 is a flowchart illustrating an example of the access setting processing S115. The access setting program 406 executes access setting between the VMs (including the virtual storage apparatus). In the virtual file storage apparatus, access setting to the virtual block storage apparatus is required.

In FIG. 20, the access setting program 406 refers to the result of the operation configuration decision processing S111 and determines whether the virtual storage apparatus accessed by the operation VM is a virtual file storage apparatus or a virtual block storage apparatus (S701). If the access destination is a virtual block storage (S701: Block), the access setting program 406 refers to the result of the operation configuration decision processing S111 and determines whether or not the operation VM and the virtual block storage apparatus operate on the same node (S702).

If the operation VM and the virtual block storage apparatus operate on the same node (S702: YES), the access setting program 406 instructs the logical partitioning program of the node and (if operating) the virtualization program to configure a logical network between the operation VM and the virtual block storage apparatus (S703). As a result, the operation VM and the virtual block storage apparatus can conduct data communication on the same node.

If the operation VM and the virtual block storage apparatus operate on different nodes (S702: NO), the access setting program 406 obtains a network identifier of the operation VM from the logical partitioning program or the virtualization program (S704) and sets the network identifier in the virtual block storage apparatus (S705). The virtual block storage apparatus allows only an access from the set network identifier and thus, the operation VM and the virtual block storage apparatus can conduct data communication on the different nodes.

If the access destination of the operation VM is the virtual file storage apparatus (S701: File), the access setting program 406 refers to the result of the operation configuration decision processing S111 and determines whether or not the virtual file storage apparatus and the virtual block storage apparatus operate on the same node (S706).

If the virtual file storage apparatus and the virtual block storage apparatus operate on the same node (S706: YES), the access setting program 406 instructs the logical partitioning program of the node to configure a logical network between the virtual file storage apparatus and the virtual block storage apparatus (S707). As a result, the virtual file storage apparatus and the virtual block storage apparatus can conduct data communication on the same node.

Moreover, the access setting program 406 makes access setting from the operation VM to the virtual file storage apparatus (S710). This is similar to the access setting from the operation VM to the virtual block storage apparatus described by referring to Step 702 to Step 705.

If the virtual file storage apparatus and the virtual block storage apparatus operate on different nodes (S706: NO), the access setting program 406 obtains a network identifier of the virtual file storage apparatus from the logical partitioning program (S708) and sets the network identifier in the virtual block storage apparatus (S706). The virtual block storage apparatus allows only an access from the set network identifier and thus, the virtual file storage apparatus and the virtual block storage apparatus can conduct data communication on the different nodes.

FIG. 21 is a flowchart illustrating an example of the resource release processing S103. The physical resource release program 407 receives a resource release request from the administrator (S801). The resource release request includes specification on whether to delete or maintain the user data of the virtual storage apparatus (specification of data to be maintained) in addition to the VM to be deleted (including the virtual storage apparatus).

For example, the administrator can specify the file or directory to be maintained in deletion of the virtual file storage apparatus and volume, data of specific address area and the like in deletion of the virtual block storage apparatus. The administrator can give a new name to the specified data.

The physical resource release program 407 refers to the received resource release request and determines whether or not release of the resource of the virtual storage apparatus (virtual block storage apparatus or virtual file storage apparatus) is required (S802). If resource release of the virtual storage apparatus is not required (S802: NO), only the operation VM is to be deleted, and the physical resource release program 407 instructs the virtualization program or the logical partitioning program to release the resource of the operation VM (S806) and updates the VM configuration table 502.

If resource release of the virtual storage apparatus is required (S802; YES), the physical resource release program 407 determines whether or not the specified user data stored in the virtual storage apparatus should be maintained (S803).

A use case example to maintain the specific data creates a first virtual storage apparatus for which high performance is not required, like a virtual storage apparatus for an archive, releases, after storing data, the first virtual storage apparatus with the stored data maintained, and creates a second virtual storage apparatus which needs high-throughput for data processing and takes over the stored data. In the use case example, the performance requirements of the first virtual storage apparatus and the second virtual storage apparatus are different. It allows limited resources to change the specification and the number of virtual storage apparatuses and operation VMs every phase and transfer data between phases.

If the specific data is to be maintained (S803: YES), the physical resource release program 407 does not erase the data and registers the data in the data table 503 of the tenant (S804). If the specific data is not to be maintained (S803: NO), the physical resource release program 407 erases the data held by the virtual storage apparatus.

Specifically, the physical resource release program 407 instructs the virtual storage apparatus to erase the data or uses a data erasing function of a storage device allocated to the logical partition where the virtual storage apparatus operates or a data erasing function of the logical partitioning program.

Subsequently, the physical resource release program 407 instructs the logical partitioning program to cease the virtual storage apparatus and release the resources of the logical partition used by the virtual storage apparatus (S805). The physical resource release program 407 updates the VM configuration table 502.

Specifically, the physical resource release program 407 deletes the entry corresponding to the VMID of the virtual storage apparatus. If releasing of operation VMs is necessary, the physical resource release program 407 instructs the logical partitioning program to release the resources of the logical partition and updates the VM configuration table 502.

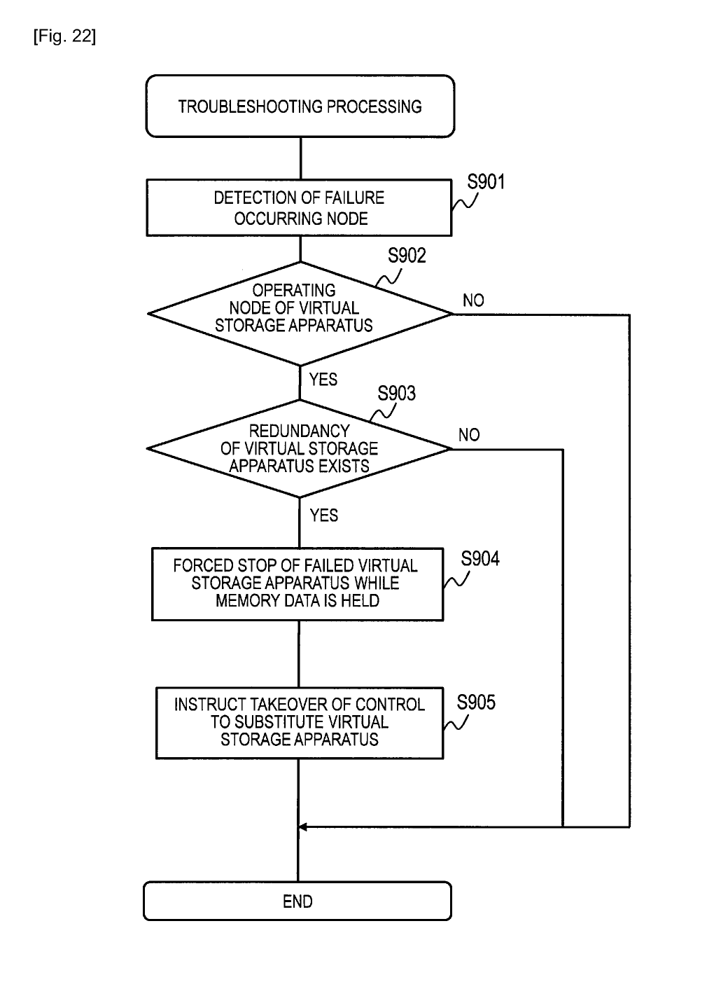

FIG. 22 is a flowchart illustrating an example of trouble shooting processing. If a failure handling program 408 detects a failure occurring node (S901), it determines whether or not the node is an operating node of the virtual block storage apparatus by referring to the VM configuration table 502 (S902). If the failed node is not an operation node of the virtual block storage apparatus (S902: NO), the failure handling program 408 finishes this flow.

If the failed node is an operating node of the virtual block storage apparatus (S902; YES), the failure handling program 408 determines whether or not there is a redundant virtual block storage apparatus of the virtual block storage apparatus by referring to the VM configuration table 502 (S903). If the virtual block storage apparatus is not redundant (S903: NO), the failure handling program 408 finishes this flow.

If the virtual storage apparatus is redundant (S903: YES), the failure handling program 408 instructs the logical partitioning program to forcedly stop the failed virtual block storage apparatus while the memory data of the failed virtual block storage apparatus is maintained (S904). After that, the failure handling program 408 further instructs an alternative virtual block storage apparatus to take over control (S905). Specifically, the program instructs the device to take over the data stored in the memory of the failed virtual block storage apparatus and to take over an access to the volume.

As described above, in this embodiment, a hardware resource can be flexibly allocated. Thus, a cloud system capable of configuring the operation VM and the virtual storage apparatus in accordance with the operation requirements can be realized.

In this embodiment, the storage apparatus (virtual storage apparatus) having physical performance guaranteed, provided with requested functions and capable of being secured can be provisioned. Moreover, in this embodiment, necessity of preparing a storage apparatus in advance in compliance with an operation having the severest requirements for a storage apparatus can be eliminated, and CAPEX reduction and resource use efficiency can be improved.

In this embodiment, a storage apparatus provided with a hardware resource in compliance with the operation requirement can be flexibly allocated by allocating a hardware resource in compliance with the requirement for an extremely I/O intensive operation application program such as processing of a large quantity of data, for example. Particularly, in the large-quantity data processing and non-structured data utilization, types of target data (video, sound, text, image, sensor data, log and the like) and application processing them are diversified, and in this embodiment, the execution basis according to them can be flexibly provided and handled.

In this embodiment, since the hardware resource for storage apparatus and the hardware resource for operation server can be used exchangeably, applications of the hardware resource can be changed in compliance with the needs, and use efficiency of the hardware resource can be improved.

The embodiment of the present invention has been described above, but the present invention is not limited to the above embodiment. It is understood by those skilled in the art that each element of the embodiment could be easily changed, added or converted within a range of the present invention.

In the above configuration example, a request to provision and to allocate a new virtual storage apparatus is received, and the new virtual storage apparatus is created in response to the request, but the management program may select and allocate a virtual storage apparatus satisfying the configuration requirement from existing virtual storage apparatuses in response to the user request. If there is no existing virtual storage apparatus satisfying the request, the management system configures a new virtual storage apparatus in accordance with the above method.

In this embodiment and other embodiments, information used by the system does not have to depend on the data structure but may be expressed in any data structure. For example, a data structural body appropriately selected from a table, a list, a database or a queue, for example, can be used to store information.

A part of or the whole of each of the above configurations, functions, processing units, processing means and the like may be realized by hardware by designing an integrated circuit or the like, for example. The information such as program, table, file and the like realizing each function may be stored in a storage device such as a non-volatile semiconductor memory, a hard disk drive, an SSD (Solid State Drive) and the like or a computer-readable non-temporary data storage medium such as an IC card, an SD card, DVD and the like.

1. A resource management system which manages a hardware resource pool including a plurality of nodes connected via a network, comprising:
node configuration information for managing a hardware configuration of each of the plurality of nodes;
virtual apparatus management information for managing virtual apparatuses including virtual storage apparatuses and virtual operation computers operating in the plurality of nodes;
virtual storage configuration condition information managing configurations of the virtual storage apparatuses and hardware resource conditions required to satisfy the configurations of the virtual storage apparatuses in association with each other; and
a processor,
wherein the processor obtains an allocation request for a first virtual storage apparatus and information of a configuration of the first virtual storage apparatus;
wherein the processor refers to the virtual storage configuration condition information to determine a hardware resource condition satisfying the configuration of the first virtual storage apparatus;
wherein the processor refers to the node management information and the virtual apparatus management information to determine a node capable of allocating a hardware resource satisfying the hardware resource condition of the first virtual storage apparatus to the first virtual storage apparatus as a node where the first virtual storage apparatus is to be configured; and
wherein the processor provides an instruction of allocation of the hardware resource to the first virtual storage apparatus and delivers a storage control program of the first virtual storage apparatus to the determined node in provisioning of the first virtual storage apparatus in the determined node.

2. The resource management system according to claim 1,
wherein the first virtual storage apparatus is a virtual file storage apparatus;
wherein the processor obtains an allocation request for a virtual block storage apparatus to which the first virtual storage apparatus connects and information of a configuration of the virtual block storage apparatus;
wherein the processor refers to the virtual storage configuration condition information to determine a hardware resource condition satisfying the configuration of the virtual block storage apparatus; and
wherein the processor refers to the node management information and the virtual apparatus management information to determine a node capable of allocating a hardware resource satisfying the hardware resource condition of the virtual block storage apparatus to the virtual block storage apparatus as a node where the virtual block storage apparatus is to be configured.

3. The resource management system according to claim 2, wherein the processor determines a node which satisfies the hardware resource conditions of the first virtual storage apparatus and the virtual block storage apparatus as a node where the first virtual storage apparatus and the virtual block storage apparatus are to be configured.

4. The resource management system according to claim 1, wherein the processor determines a node of an operation virtual computer accessing the first virtual storage apparatus which is capable of allocating a hardware resource satisfying the hardware resource condition of the first virtual storage apparatus to the first virtual storage apparatus as a node where the first virtual storage apparatus is to be configured.

5. The resource management system according to claim 1,
wherein the first virtual storage apparatus is a virtual file storage apparatus; and
wherein the processor determines a node of a virtual block storage apparatus to which the first virtual storage apparatus makes an access and an operation virtual computer accessing the first virtual storage apparatus which is capable of allocating a hardware resource satisfying the hardware resource condition of the first virtual storage apparatus to the first virtual storage apparatus as a node where the first virtual storage apparatus is to be configured.

6. The resource management system according to claim 1,
wherein the first virtual storage apparatus is a virtual block storage apparatus;
wherein the processor obtains an allocation request for a redundant virtual block storage apparatus of the first virtual storage apparatus and information of a configuration of the redundant virtual block storage apparatus;
wherein the processor refers to the virtual storage configuration condition information to determine a hardware resource condition satisfying the configuration of the redundant virtual block storage apparatus; and
wherein the processor refers to the node management information and the virtual apparatus management information to determine a node which is different from the node of the first virtual storage apparatus and capable of allocating a hardware resource satisfying the hardware resource condition of the redundant virtual block storage apparatus to the redundant virtual block storage apparatus and in which the redundant virtual block storage apparatus can access data of the first virtual storage apparatus as a node where the redundant virtual block storage apparatus is to be configured.

7. The resource management system according to claim 1, wherein the processor obtains a request for deletion of an operating virtual storage apparatus, and instructs the node where the operating virtual storage apparatus is configured to delete the operating virtual storage apparatus and release of a hardware resource used by the operating virtual storage apparatus.

8. The resource management system according to claim 7, wherein the processor instructs release of the hardware resource used by the operating virtual storage apparatus with existing data managed by the operating virtual storage apparatus maintained in a storage device.

9. The resource management system according to claim 1,
wherein the management system further includes data management information which manages existing data and a storage device storing the existing data for each tenant;
wherein the request is a request from a first tenant and instructs that the virtual storage apparatus should hold first existing data of the first tenant;
wherein the processor refers to the data management information and identifies a storage device storing the first existing data; and
wherein the processor determines a node capable of directly accessing the storage device storing the first existing data and allocating a hardware resource satisfying the hardware resource condition of the first virtual storage apparatus to the first virtual storage apparatus as a node where the first virtual storage apparatus is to be configured.

10. The resource management system according to claim 1, wherein a storage device allocated to the first storage apparatus is dedicated to the first storage apparatus.

11. A resource managing method performed by a resource management system for managing a hardware resource pool including a plurality of nodes connected via a network, comprising:
obtaining, by the resource management system, an allocation request for a first virtual storage apparatus and information of a configuration of the first virtual storage apparatus;
referring, by the resource management system, to virtual storage configuration condition information which manages a configuration of the virtual storage apparatus and a hardware resource condition required to satisfy the configuration in association with each other to determine the hardware resource condition satisfying the configuration of the first virtual storage apparatus;
referring, by the resource management system, to node management information managing a hardware configuration of each of the plurality of nodes and virtual apparatus management information managing virtual storage apparatuses including virtual storage apparatuses and virtual operation computers operating on the plurality of nodes to determine a node capable of allocating a hardware resource satisfying the hardware resource condition of the first virtual storage apparatus to the first virtual storage apparatus as a node where the first virtual storage apparatus is to be configured; and
providing, by the resource management system, an instruction of allocation of the hardware resource to the first virtual storage apparatus and delivering a storage control program of the first virtual storage apparatus to the determined node in provisioning of the first virtual storage apparatus in the determined node.

12. The resource managing method according to claim 11, wherein the first virtual storage apparatus is a virtual file storage apparatus, and the resource managing method further comprising:
obtaining, by the resource management system, an allocation request for a virtual block storage apparatus to which the first virtual storage apparatus connects and information of a configuration of the virtual block storage apparatus;
referring, by the resource management system, to the virtual storage configuration condition information to determine a hardware resource condition satisfying the configuration of the virtual block storage apparatus; and
referring, by the resource management system, to the node management information and the virtual apparatus management information to determine a node capable of allocating a hardware resource satisfying the hardware resource condition of the virtual block storage apparatus to the virtual block storage apparatus as a node where the virtual block storage apparatus is to be configured.

13. The resource managing method according to claim 11,
wherein the first virtual storage apparatus is a virtual file storage apparatus; and
wherein the determining the node where the first virtual storage apparatus is to be configured determines a node of a virtual block storage apparatus to which the first virtual storage apparatus makes access and an operation virtual computer accessing the first virtual storage apparatus which is capable of allocating a hardware resource satisfying the hardware resource condition of the first virtual storage apparatus to the first virtual storage apparatus as the node where the first virtual storage apparatus is to be configured.

14. The resource managing method according to claim 11, wherein the first virtual storage apparatus is a virtual block storage apparatus, and the resource managing method further comprising:
obtaining, by the resource management system, an allocation request for a redundant virtual block storage apparatus of the first virtual storage apparatus and information of a configuration of the redundant virtual block storage apparatus;
referring, by the resource management system, to the virtual storage configuration condition information to determine a hardware resource condition satisfying the configuration of the redundant virtual block storage apparatus; and
referring, by the resource management system, to the node management information and the virtual apparatus management information to determine a node which is different from the node of the first virtual storage apparatus, which is capable of allocating a hardware resource satisfying the hardware resource condition of the redundant virtual block storage apparatus to the redundant virtual block storage apparatus and in which the redundant virtual block storage apparatus is capable of accessing data of the first virtual storage apparatus as a node where the redundant virtual block storage apparatus is to be configured.

15. The resource managing method according to claim 11 further comprising:
obtaining, by the resource management system, a request of deletion of an operating virtual storage apparatus with existing data of the operating virtual storage apparatus maintained; and
instructing, by the resource management system, the node where the operating virtual storage apparatus is configured to delete the operating virtual storage apparatus and to release a hardware resource used by the operating virtual storage apparatus with the existing data maintained in a storage device.
